(19) United States
(12) Patent Application Publication
(10) Pub. No.: US 2024/0011250 A1
(43) Pub. Date: Jan. 11, 2024

(54) SHOVEL AND CONSTRUCTION MANAGEMENT SYSTEM

(71) Applicant: SUMITOMO HEAVY INDUSTRIES, LTD., Tokyo (JP)

(72) Inventors: Masaki OGAWA, Kanagawa (JP); Keisuke SATOH, Kanagawa (JP)

(21) Appl. No.: 18/470,700

(22) Filed: Sep. 20, 2023

Related U.S. Application Data
(63) Continuation of application No. PCT/JP2022/014150, filed on Mar. 24, 2022.

(30) Foreign Application Priority Data
Mar. 25, 2021 (JP) 2021-051820

(51) Int. Cl. E02F 9/26; E02F 9/20; G05D 1/02

(52) U.S. Cl. CPC E02F 9/261; E02F 9/205; E02F 9/2054; G05D 1/0227; G05D 1/0291; E02F 9/2285

(57) ABSTRACT

A shovel includes a determination part that presses a working portion of an end attachment against a ground, and determines presence or absence of a soft ground region in the ground, and a control part that permits the shovel to travel by a predetermined distance in response to the determination part determining the absence of the soft ground region.

### CROSS-REFERENCE TO RELATED APPLICATIONS

This application is a continuation application filed under 35 U.S.C. 111(a) claiming benefit under 35 U.S.C. 120 and 365(c) of PCT International Application No. PCT/JP2022/014150, filed on Mar. 24, 2022 and designating the U.S., which claims priority to Japanese Patent Application No. 2021-051820, filed on Mar. 25, 2021. The entire contents of the foregoing applications are incorporated herein by reference.

### BACKGROUND

### Technical Field

The present disclosure relates to shovels and construction management systems.

### Description of Related Art

So far, shovels that travel using hydraulic motors as drive sources have been known.

### SUMMARY

According to one aspect of the present disclosure, a shovel includes: a determination part that presses a working portion of an end attachment against the ground, and determines the presence or absence of a soft ground region in the ground; and a control part that permits the shovel to travel by a predetermined distance in response to the determination part determining the absence of the soft ground region.

According to another aspect of the present disclosure, a construction management system is a construction management system that manages a plurality of shovels, in which the shovels include: a determination part that presses a working portion of an end attachment against the ground, and determines the presence or absence of a soft ground region in the ground; a control part that permits a shovel to travel by a predetermined distance in response to the determination part determining the absence of the soft ground region; and an output part that outputs route information indicating a traveling route through which the shovel travels from a current position of the shovel to a destination based on a determination result of the determination part, and the construction management system includes a communication part that transmits the route information, which is output from the shovel, to another shovel.

### BRIEF DESCRIPTION OF THE DRAWINGS

FIG. 1 is a side view of a shovel according to the present embodiment;

FIG. 2 is a top view of the shovel according to the present embodiment;

FIG. 3 is a block diagram of one example of a configuration of the shovel according to the present embodiment;

FIG. 4 is a view illustrating one example of a hydraulic circuit of a hydraulic drive system;

FIG. 5A is a view illustrating one example of a pilot circuit that applies a pilot pressure to a control valve that hydraulically controls a boom cylinder;

FIG. 5B is a view illustrating one example of a pilot circuit that applies a pilot pressure to a control valve that hydraulically controls an arm cylinder;

FIG. 5C is a view illustrating one example of a pilot circuit that applies a pilot pressure to a control valve that hydraulically controls a bucket cylinder;

FIG. 6 is an explanatory view of functions of a controller of the shovel;

FIG. 7 is a schematic view illustrating a relationship between forces applied to the shovel (attachment) upon compaction operation;

FIG. 8 is a functional block diagram illustrating a functional configuration in relation to compaction assist control by a controller;

FIG. 9 is one example illustrating a situation of the compaction operation by the shovel;

FIG. 10 is an explanatory view of movement of the shovel;

FIG. 11 is a view illustrating effects of the present embodiment;

FIG. 12 is a view illustrating one example of a system configuration of a construction management system;

FIG. 13 is a view illustrating one example of a hardware configuration of a construction management device;

FIG. 14 is an explanatory view illustrating functions of the construction management device;

FIG. 15 is a sequence diagram illustrating an operation of the construction management system;

FIG. 16 is a flowchart illustrating a process of the construction management device; and

FIG. 17 is a flowchart illustrating movement of the shovel that follows a track.

### DETAILED DESCRIPTION

When soft ground regions are present in construction sites where shovels work, it is sometimes difficult to visually recognize and avoid such soft ground regions due to, for example, the positions of the soft ground regions and the geography of the construction sites.

Under such circumstances, it is desirable to avoid entry into the soft ground regions.

### Embodiments

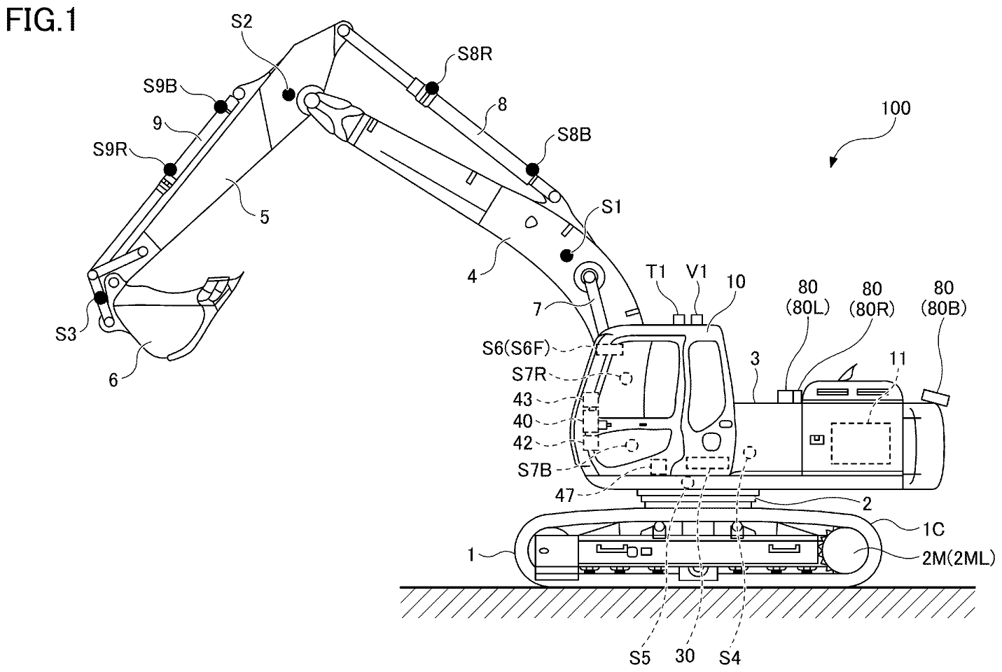

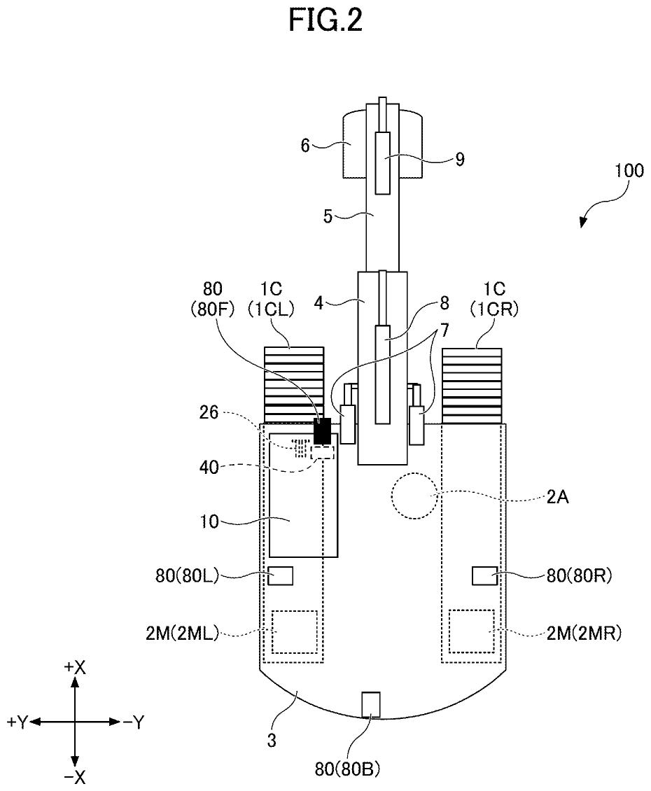

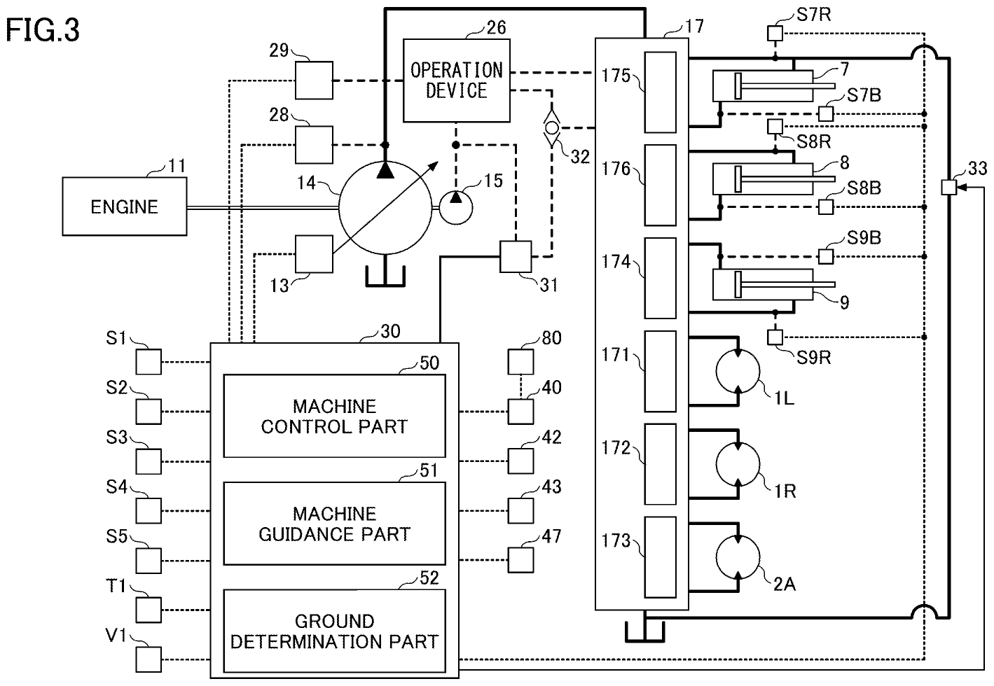

First, referring to FIG. 1 to FIG. 3, the outline of the shovel according to the present embodiment will be described. FIG. 1 is a side view of the shovel according to the present embodiment, FIG. 2 is a top view of the shovel according to the present embodiment, and FIG. 3 is a block diagram of one example of the configuration of the shovel according to the present embodiment.

A shovel 100 according to the present embodiment includes: a lower traveling body 1; an upper swiveling body 3 rotatably mounted to the lower traveling body 1 via a swiveling mechanism 2; a boom 4, an arm 5, and a bucket 6 as attachments; and a cab 10.

For example, the lower traveling body 1 (one example of the traveling body) includes a left-and-right pair of crawlers 1C (see FIG. 2). The shovel 100 travels by the respective crawlers that are hydraulically driven with a traveling hydraulic motor 2M.

The swiveling body 3 (one example of the swiveling body) swivels with respect to the lower traveling body 1 by being driven with a swiveling hydraulic motor 2A (see FIG. 2).

The boom 4 is pivotally attached to a front center portion of the upper swiveling body 3 so as to be able to elevate and depress. The arm 5 is pivotally attached to the front end of the boom 4 so as to be rotatable and movable upward and downward. The bucket 6 is pivotally attached to the front end of the arm 5 so as to be rotatable and movable upward and downward. The boom 4, the arm 5, and the end attachment bucket 6 (each of which is one example of a link portion) are hydraulically driven by corresponding hydraulic actuators, i.e., a boom cylinder 7, an arm cylinder 8, and a bucket cylinder 9.

The cab 10 is an operating room that an operator gets in, and is provided on the front-left side of the upper swiveling body 3.

A photographing device 80 is another example of a space recognition device, and is configured to photograph the surroundings of the shovel 100. Note that, the shovel 100 may include an object detection device as one example of the space recognition device. The space recognition device of the present embodiment may be configured in a given manner as long as the space recognition device can identify a positional relationship between the surrounding objects and the shovel 100.

In the example of FIG. 2, the photographing device 80 may include: a camera 80B attached at the back end of the upper surface of the upper swiveling body 3; a camera 80L attached at the left-hand end of the upper surface of the upper swiveling body 3; and a camera 80R attached at the right-hand end of the upper surface of the upper swiveling body 3. The photographing device 80 may include a camera 80F.

Images photographed by the photographing device 80 are displayed on a display device 40 disposed in the cab 10. The photographing device 80 may be configured to display, on the display device 40, a viewpoint-converted image such as an overhead image. The overhead image is generated by, for example, synthesizing the images output from the camera 80B, the camera 80L, and the camera 80R.

With this configuration, the shovel 100 can display, on the display device 40, an image of an object detected by the photographing device 80. Therefore, when the movement of what the operator of the shovel 100 intended to drive has been restricted or prohibited, the operator can immediately confirm a causal object by looking at the image displayed on the display device 40.

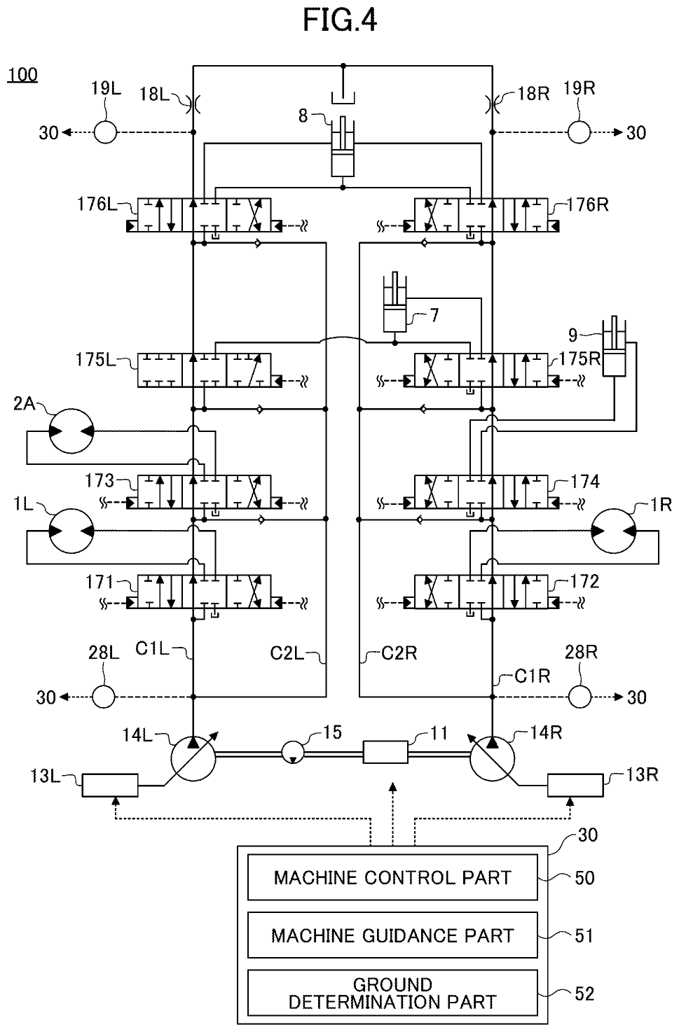

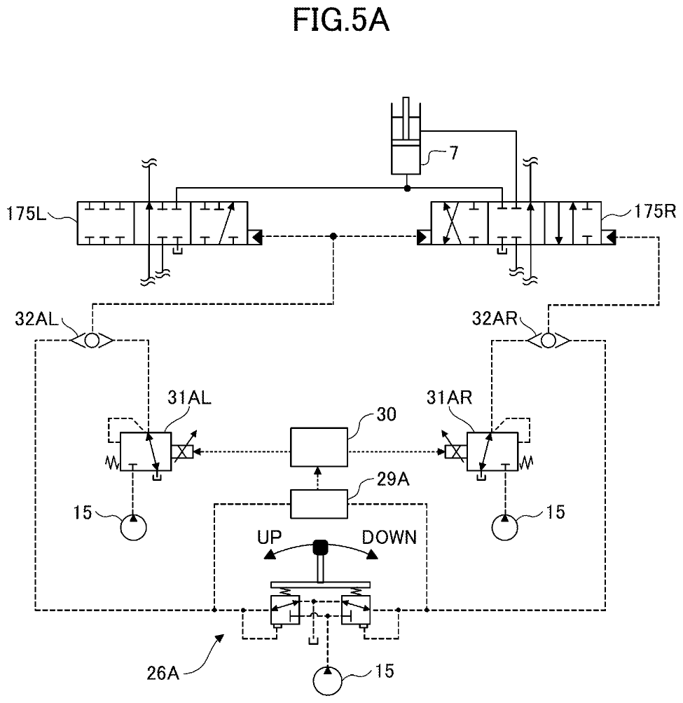

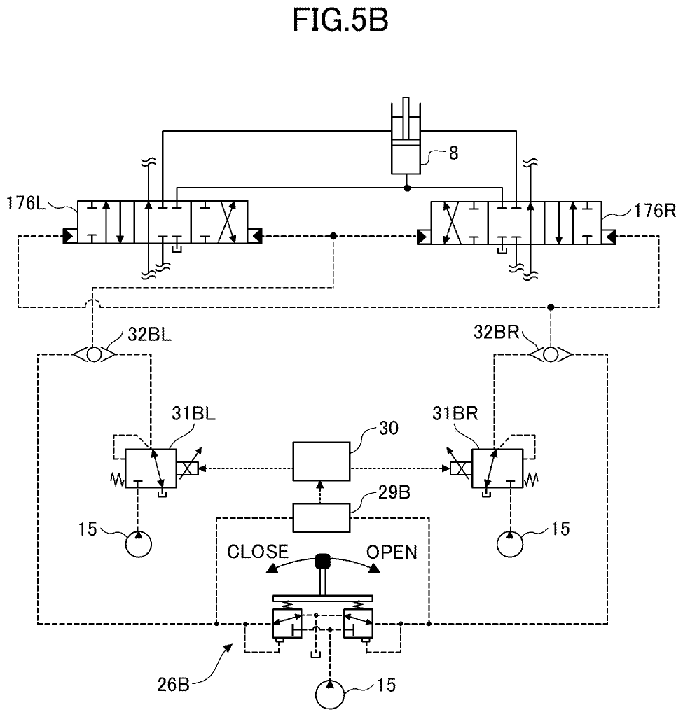

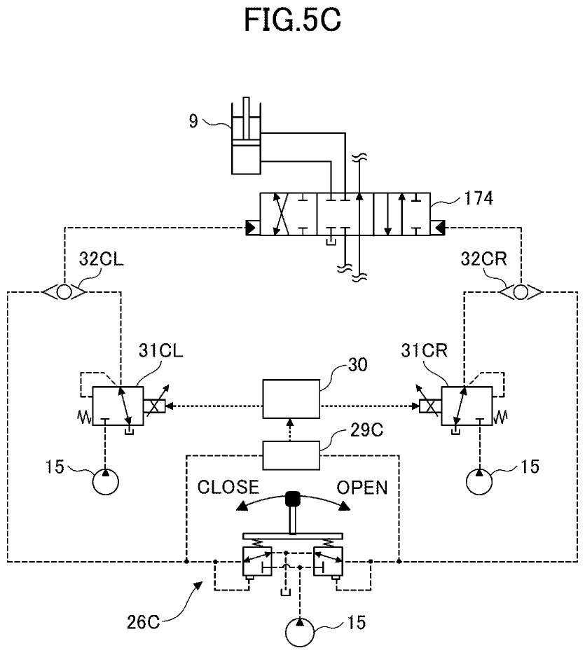

Next, referring to FIG. 3, the configuration of the shovel 100 will be further described. Note that, in the figure, the mechanical power line is denoted by a double line, the high-pressure hydraulic line is by a solid line, the pilot line is by a dashed line, and the electrical driving/control line is by a dotted line. In the following, the same applies to FIG. 4 and FIG. 5A to FIG. 5C.

A hydraulic drive system that hydraulically drives hydraulic actuators of the shovel 100 according to the present embodiment includes an engine 11, a regulator 13, a main pump 14, and a control valve 17. Also, the hydraulic drive system of the shovel 100 according to the present embodiment includes, as described above, the hydraulic actuators such as traveling hydraulic motors 1L and 1R, the swiveling hydraulic motor 2A, the boom cylinder 7, the arm cylinder 8, and the bucket cylinder 9 that hydraulically drive the lower traveling body 1, the upper swiveling body 3, the boom 4, the arm 5, and the bucket 6, respectively.

The engine 11 is a main power source in the hydraulic drive system and is provided, for example, at the back portion of the upper swiveling body 3. Specifically, the engine 11 constantly rotates at a preset target rotation speed under direct or indirect control by a controller 30 described below, thereby driving the main pump 14 and a pilot pump 15. The engine 11 is, for example, a diesel engine using diesel oil as a fuel.

The regulator 13 controls the discharge amount of the main pump 14. For example, the regulator 13 adjusts the angle of a swashplate (tilting angle) of the main pump 14 in accordance with a control command from the controller 30. As described below, for example, the regulator 13 includes regulators 13L and 13R.

Similar to the engine 11, the main pump 14 is provided, for example, at the back portion of the upper swiveling body 3, and feeds hydraulic oil to the control valve 17 through the high-pressure hydraulic line. The main pump 14 is, as described above, driven by the engine 11. The main pump 14 is, for example, a variable displacement hydraulic pump. As described above, when the tilting angle of the swashplate is adjusted by the regulator 13 under control by the controller 30, the stroke length of the piston is adjusted and the discharge flow rate (discharge pressure) can be controlled. For example, the main pump 14 includes main pumps 14L and 14R as described below.

The control valve 17 is, for example, a hydraulic control device that is provided at the center portion of the upper swiveling body 3, and controls the hydraulic drive system in accordance with operation by the operator on an operation device 26.

As described above, the control valve 17 is connected to the main pump 14 via the high-pressure hydraulic line, and selectively feeds the hydraulic oil, which has been fed from the main pump 14, to the hydraulic actuators (the traveling hydraulic motors 1L and 1R, the swiveling hydraulic motor 2A, the boom cylinder 7, the arm cylinder 8, and the bucket cylinder 9) in accordance with the operation state of the operation device 26.

Specifically, the control valve 17 includes control valves 171 to 176 that control the flow rate and flow direction of the hydraulic oil fed from the main pump 14 to each of the hydraulic actuators.

The control valve 171 corresponds to the traveling hydraulic motor 1L, the control valve 172 corresponds to the traveling hydraulic motor 1R, the control valve 173 corresponds to the swiveling hydraulic motor 2A, the control valve 174 corresponds to the bucket cylinder 9, the control valve 175 corresponds to the boom cylinder 7, and the control valve 176 corresponds to the arm cylinder 8. Also, for example, the control valve 175 includes control valves 175L and 175R as described below, and for example, the control valve 176 includes control valves 176L and 176R as described below. Details of the control valves 171 to 176 will be described below (see FIG. 4).

The operation system of the shovel 100 according to the present embodiment includes the pilot pump 15 and the operation device 26. Also, the operation system of the shovel 100 includes a shuttle valve 32 as a configuration in relation to the below-described automatic control function by the controller 30.

The pilot pump 15 is provided, for example, at the back portion of the upper swiveling body 3, and applies a pilot pressure to the operation device 26 via the pilot line. The pilot pump 15 is, for example, a fixed displacement hydraulic pump and is driven by the engine 11 as described above.

The operation device 26 is provided near an operator's seat in the cab 10, and is an operation input unit configured for the operator to operate various moving elements (e.g., the lower traveling body 1, the upper swiveling body 3, the boom 4, the arm 5, and the bucket 6). In other words, the operation device 26 is an operation input unit configured for the operator to operate the hydraulic actuators that drive the respective moving elements (i.e., the traveling hydraulic motors 1L and 1R, the swiveling hydraulic motor 2A, the boom cylinder 7, the arm cylinder 8, and the bucket cylinder 9).

The operation device 26 is directly connected to the control valve 17 through the pilot line on the secondary side thereof, or is indirectly connected to the control valve 17 via the below-described shuttle valve 32 provided in the pilot line on the secondary side thereof.

Thereby, the control valve 17 can receive an input of the pilot pressures in accordance with the operation states of, for example, the lower traveling body 1, the upper swiveling body 3, the boom 4, the arm 5, and the bucket 6, in the operation device 26. Therefore, the control valve 17 can drive the respective hydraulic actuators in accordance with the operation states in the operation device 26.

As described below, the operation device 26 includes lever devices 26A to 26D that operate the attachments, i.e., the boom 4 (boom cylinder 7), the arm 5 (arm cylinder 8), and the bucket 6 (bucket cylinder 9) (see FIG. 5A to FIG. 5C). Also, for example, the operation device 26 is provided with pedal devices that operate the left and right lower traveling bodies 1 (traveling hydraulic motors 1L and 1R).

The shuttle valve 32 includes two inlet ports and one outlet port, and outputs, from the outlet port, the hydraulic oil having the higher pilot pressure of the pilot pressures input to the two inlet ports. One of the two inlet ports of the shuttle valve 32 is connected to the operation device 26, and the other is connected to a proportional valve 31.

The outlet port of the shuttle valve 32 is connected through the pilot line to a pilot port of the corresponding control valve in the control valve 17 (for details, see FIG. 5A to FIG. 5C). Therefore, the shuttle valve 32 can apply, to the pilot port of the corresponding control valve, the higher pilot pressure of the pilot pressure generated by the operation device 26 and the pilot pressure generated by the proportional valve 31.

In other words, the below-described controller 30 outputs, from the proportional valve 31, the pilot pressure higher than the secondary-side pilot pressure output from the operation device 26, and can control the corresponding control valves to control the movements of the attachments regardless of the operation by the operator on the operation device 26. For example, the shuttle valve 32 includes shuttle valves 32AL, 32AR, 32BL, 32BR, 32CL, and 32CR as described below.

The control system of the shovel 100 according to the present embodiment includes the controller 30, a discharge pressure sensor 28, an operation pressure sensor 29, the proportional valve 31, a relief valve 33, the display device 40, an input device 42, a sound output device 43, a storage device 47, a boom angle sensor S1, an arm angle sensor S2, a bucket angle sensor S3, a machine body tilt sensor S4, a swiveling state sensor S5, the photographing device 80, a boom rod pressure sensor S7R, a boom bottom pressure sensor S7B, an arm rod pressure sensor S8R, an arm bottom pressure sensor S8B, a bucket rod pressure sensor S9R, a bucket bottom pressure sensor S9B, a position measurement device V1, and a communication device T1.

The controller 30 (one example of the control device) is provided, for example, in the cab 10, and controls the drive of the shovel 100. The functions of the controller 30 may be realized by given hardware or by a combination of hardware and software.

For example, the controller 30 mainly includes: a processor such as a CPU (Central Processing Unit); a memory device such as a PAM (Random Access Memory); a non-volatile auxiliary storage device such as a ROM (Read Only Memory); and a microcomputer including, for example, an interface device for various inputs and outputs. The controller 30 realizes various functions by, for example, executing various programs stored in the non-volatile auxiliary storage device on the CPU.

For example, the controller 30 sets the target rotation speed of the engine 11 based on, for example, a working mode preset by a predetermined operation of the operator or the like, and controls the drive of the engine 11 so as to constantly rotate.

Also, for example, the controller 30, if necessary, outputs a control command to the regulator 13, and changes the discharge amount of the main pump 14.

Also, the controller 30 includes a machine control part 50, a machine guidance part 51, and a ground determination part 52.

The machine control part 50 performs, for example, control in relation to a machine control function that automatically assists a manual operation of the shovel 100 by the operator through the operation device 26.

The machine guidance part 51 performs, for example, control in relation to a machine guidance function that guides the manual operation of the shovel 100 by the operator through the operation device 26.

The ground determination part 52 determines the presence or absence of the soft ground region in the traveling direction of the shovel 100, and permits movement toward the traveling direction in response to determining the absence of the soft ground region. Details of each part included in the controller 30 will be described below.

Note that, a part of the functions of the controller 30 may be realized by another controller (control device). In other words, the functions of the controller 30 may be separately realized by a plurality of controllers. For example, the above-described machine guidance function and machine control function may be realized by dedicated controllers (control devices).

The discharge pressure sensor 28 detects the discharge pressure of the main pump 14. A detection signal corresponding to the discharge pressure, which has been detected by the discharge pressure sensor 28, is input to the controller 30. For example, the discharge pressure sensor 28 includes discharge pressure sensors 28L and 28R as described below.

As described above, the operation pressure sensor 29 detects the pilot pressure on the secondary side of the operation device 26, i.e., the pilot pressure corresponding to the operation state of each moving element (hydraulic actuator) in the operation device 26. Detection signals of the pilot pressures, which have been detected by the operation pressure sensor 29, corresponding to the operation states of, for example, the lower traveling body 1, the upper swiveling body 3, the boom 4, the arm 5, and the bucket 6 in the operation device 26 are input to the controller 30. For example, the operation pressure sensor 29 includes operation pressure sensors 29A to 29C as described below.

The proportional valve 31 is provided in the pilot line connecting the pilot pump 15 and the shuttle valve 32 to each other, and is configured such that the flow path area thereof (cross-sectional area through which the hydraulic oil can pass) can be changed. The proportional valve 31 operates in accordance with a control command input from the controller 30.

Thereby, even if the operation device 26 (specifically, lever devices 26A to 26C) is not operated by the operator, the controller 30 can feed the hydraulic oil, discharged from the pilot pump 15, to the pilot port of the corresponding control valve in the control valve 17 via the proportional valve 31 and the shuttle valve 32. For example, the proportional valve 31 includes proportional valves 31AL, 31AR, 31BL, 31BR, 31CL, and 31CR as described below.

In accordance with a control signal (control current) from the controller 30, the relief valve 33 discharges, to a tank, the hydraulic oil of the rod-side oil chamber of the boom cylinder 7, and suppresses excessive pressure of the rod-side oil chamber of the boom cylinder 7.

The display device 40 is disposed in a place where the display device 40 is readily visually recognized by the operator sitting in the cab 10. The display device 40 displays various information images under control by the controller 30. The display device 40 may be connected to the controller 30 via an in-vehicle communication network such as a CAN (Controller Area Network) or may be connected to the controller 30 via a one-to-one dedicated line.

The input device 42 is disposed within reach from the operator sitting in the cab 10, and receives various operation inputs from the operator and outputs signals in accordance with the operation inputs to the controller 30. The input device 42 includes: a touch panel mounted in the display of the display device that displays the various information images; a knob switch provided at the top end of a lever portion of the lever devices 26A to 26C; and a button switch, a lever, a toggle, and the like that are disposed around the display device 40. A signal corresponding to an operation content on the input device 42 is input to the controller 30.

The sound output device 43 is provided, for example, in the cab 10 and connected to the controller 30, and outputs sound under control by the controller 30. The sound output device 43 is, for example, a speaker or a buzzer. The sound output device 43 outputs various information as sound in accordance with a sound output command from the controller 30.

The storage device 47 is provided, for example, in the cab 10, and stores the various information under control by the controller 30. The storage device 47 is, for example, a non-volatile recording medium such as a semiconductor memory. The storage device 47 may store information output by various devices during operation of the shovel 100, or may store information obtained via various devices before the start of the operation of the shovel 100.

The storage device 47 may store data in relation to a target construction surface that are obtained via, for example, the communication device T1 or are set through, for example, the input device 42. The target construction surface may be set (stored) by the operator of the shovel 100 or may be set by, for example, a construction manager.

The boom angle sensor S1 is attached to the boom 4, and detects elevation and depression angles of the boom 4 relative to the upper swiveling body 3 (hereinafter referred to as a “boom angle”); e.g., in a side view, an angle formed between a straight line connecting the fulcrums at both ends of the boom 4 and a swiveling flat surface of the upper swiveling body 3.

The boom angle sensor S1 may include a rotary encoder, an acceleration sensor, a 6-axis sensor, an IMU (Inertial Measurement Unit), and the like. In the following, the same applies to the arm angle sensor S2, the bucket angle sensor S3, and the machine body tilt sensor S4. A detection signal corresponding to the boom angle detected by the boom angle sensor S1 is input to the controller 30.

The arm angle sensor S2 is attached to the arm 5, and detects a pivotally swiveling angle of the arm 5 relative to the boom 4 (hereinafter referred to as an “arm angle”); e.g., in a side view, an angle formed between a straight line connecting the fulcrums at both ends of the boom 4 and a straight line connecting the fulcrums at both ends of the arm 5. A detection signal corresponding to the arm angle detected by the arm angle sensor S2 is input to the controller 30.

The bucket angle sensor S3 is attached to the bucket 6, and detects a pivotally swiveling angle of the bucket 6 relative to the arm 5 (hereinafter referred to as a “bucket angle”); e.g., in a side view, an angle formed between a straight line connecting the fulcrums at both ends of the arm 5 and a straight line connecting the fulcrum of the bucket 6 to the front end (blade tip). A detection signal corresponding to the bucket angle detected by the bucket angle sensor S3 is input to the controller 30.

The machine body tilt sensor S4 detects a tilt state of the machine body (the upper swiveling body 3 or the lower traveling body 1) relative to the horizontal surface. The machine body tilt sensor S4 is, for example, attached to the upper swiveling body 3, and detects tilt angles about two axes of a front-back direction and a left-right direction of the shovel 100 (i.e., the upper swiveling body 3) (hereinafter referred to as “front-back tilt angle” and “left-right tilt angle”). Detection signals corresponding to the tilt angles (the front-back tilt angle and the left-right tilt angle) detected by the machine body tilt sensor S4 are input to the controller 30.

The swiveling state sensor S5 outputs detection information in relation to the swiveling state of the upper swiveling body 3. The swiveling state sensor S5 detects, for example, a swiveling angular velocity and a swiveling angle of the upper swiveling body 3. The swiveling state sensor S5 includes a gyro sensor, a resolver, a rotary encoder, and the like.

The photographing device 80 photographs the surroundings of the shovel 100. The photographing device 80 includes the camera 80F that photographs forward from the shovel 100, the camera 80L that photographs leftward from the shovel 100, the camera 80R that photographs rightward from the shovel 100, and the camera 80B that photographs backward from the shovel 100.

The camera 80F is, for example, attached to the ceiling of the cab 10, i.e., the interior of the cab 10. Also, the camera 80F may be attached to the exterior of the cab 10, such as the roof of the cab 10 or the side surface of the boom 4. The camera 80L is attached at the left end of the upper surface of the upper swiveling body 3, the camera 80R is attached at the right-hand end of the upper surface of the upper swiveling body 3, and the camera 80B is attached at the back end of the upper surface of the upper swiveling body 3.

The photographing device 80 (cameras 80F, 80B, 80L, and 80R) is, for example, a monocular wide-angle camera having a very wide angle of view. Also, the photographing device 80 may be, for example, a stereo camera or a distance image camera. A photographed image taken by the photographing device 80 is input to the controller 30 via the display device 40.

Also, the photographing device 80 may also function as an object detection device. In this case, the photographing device 80 may detect an object existing around the shovel 100. The object to be detected can include geographical features (e.g., slopes and holes), people, animals, vehicles, construction machines, buildings, walls, helmets, safety vests, work clothes, predetermined marks on helmets, or the like.

Also, the photographing device 80 may calculate the distance from the photographing device 80 or the shovel 100 to the recognized object. The photographing device 80 serving as the space recognition device can include ultrasonic sensors, millimeter-wave radars, stereo cameras, LIDAR (Light Detection and Ranging), distance image cameras, infrared sensors, and the like. Also, the space recognition device may be, for example, a monocular camera having a photographing element such as a CCD (Charge-Coupled Device) image sensor or a CMOS (Complementary Metal-Oxide-Semiconductor) image sensor, and may output a photographed image to the display device 40. Also, the space recognition device may be configured to calculate the distance from the space recognition device or the shovel 100 to the recognized object.

When a millimeter-wave radar, an ultrasonic sensor, a laser radar, or the like is used as the space recognition device in addition to using the image information to be obtained by photographing, many signals (i.e., a millimeter wave, an ultrasonic wave, laser light, or the like) may be emitted to the surroundings, and reflected signals thereof may be received, thereby detecting the distances and the directions of the objects from the reflected signals.

In this way, the space recognition device may be configured to identify the type, position, shape, or the like of the object, or any combination thereof. For example, the space recognition device may be configured to distinguish a person from an object other than the person.

Note that, the photographing device 80 may be connected to the controller 30 directly and communicably.

The boom rod pressure sensor S7R and the boom bottom pressure sensor S7B are attached to the boom cylinder 7, and detect the pressure of the rod-side oil chamber of the boom cylinder 7 (hereinafter referred to as a “boom rod pressure”) and the pressure of the bottom-side oil chamber of the boom cylinder 7 (hereinafter referred to as a “boom bottom pressure”). Detection signals corresponding to the boom rod pressure and the boom bottom pressure detected by the boom rod pressure sensor S7R and the boom bottom pressure sensor S7B are input to the controller 30.

The arm rod pressure sensor S8R and the arm bottom pressure sensor S8B are attached to the arm cylinder 8, and detect the pressure of the rod-side oil chamber of the arm cylinder 8 (hereinafter referred to as an “arm rod pressure”) and the pressure of the bottom-side oil chamber of the arm cylinder 8 (hereinafter referred to as an “arm bottom pressure”). Detection signals corresponding to the arm rod pressure and the arm bottom pressure detected by the arm rod pressure sensor S8R and the arm bottom pressure sensor S8B are input to the controller 30.

The bucket rod pressure sensor S9R and the bucket bottom pressure sensor S9B are attached to the bucket cylinder 9, and detect the pressure of the rod-side oil chamber of the bucket cylinder 9 (hereinafter referred to as a “bucket rod pressure”) and the pressure of the bottom-side oil chamber of the bucket cylinder 9 (hereinafter referred to as a “bucket bottom pressure”).

Detection signals corresponding to the bucket rod pressure and the bucket bottom pressure detected by the bucket rod pressure sensor S9R and the bucket bottom pressure sensor S9B are input to the controller 30.

The position measurement device V1 measures the position and the orientation of the upper swiveling body 3. The position measurement device V1 is, for example, a GNSS (Global Navigation Satellite System) compass, and detects the position and the orientation of the upper swiveling body 3. Detection signals corresponding to the position and the orientation of the upper swiveling body 3 are input to the controller 30. Also, of the functions of the position measurement device V1, the function of detecting the orientation of the upper swiveling body 3 may be, instead, realized by an orientation sensor attached to the upper swiveling body 3.

The communication device T1 performs communication with an external device through a predetermined network, which includes a mobile communication network in which base stations are the terminals, a satellite communication network, the Internet network, or the like. For example, the communication device T1 is a mobile communication module responding to a mobile communication standard (e.g., LTE (Long Term Evolution), 4G (4th Generation), or 5G (5th Generation)) or is a satellite communication module for connecting to the satellite communication network.

Next, referring to FIG. 4, a hydraulic circuit of the hydraulic drive system that drives the hydraulic actuators will be described. FIG. 4 is a view illustrating one example of the hydraulic circuit of the hydraulic drive system.

A hydraulic system realized by the hydraulic circuit circulates the hydraulic oil from the respective main pumps 14L and 14R driven by the engine 11 to a hydraulic oil tank through center bypass oil paths C1L and C1R and parallel oil paths C2L and C2R.

The center bypass oil path C1L starts with the main pump 14L, and sequentially passes through the control valves 171, 173, 175L, and 176L disposed in the control valve 17 and reaches the hydraulic oil tank.

The center bypass oil path C1R starts with the main pump 14R, and sequentially passes through the control valves 172, 174, 175R, and 176R disposed in the control valve 17 and reaches the hydraulic oil tank.

The control valve 171 is a spool valve that feeds the hydraulic oil discharged from the main pump 14L to the traveling hydraulic motor 1L, and discharges the hydraulic oil discharged from the traveling hydraulic motor 1L to the hydraulic oil tank.

The control valve 172 is a spool valve that feeds the hydraulic oil discharged from the main pump 14R to the traveling hydraulic motor 1R, and discharges the hydraulic oil discharged from the traveling hydraulic motor 1R to the hydraulic oil tank.

The control valve 173 is a spool valve that feeds the hydraulic oil discharged from the main pump 14L to the swiveling hydraulic motor 2A, and discharges the hydraulic oil discharged from the swiveling hydraulic motor 2A to the hydraulic oil tank.

The control valve 174 is a spool valve that feeds the hydraulic oil discharged from the main pump 14R to the bucket cylinder 9, and discharges the hydraulic oil in the bucket cylinder 9 to the hydraulic oil tank.

The control valves 175L and 175R are spool valves that feed the hydraulic oil discharged from the main pumps 14L and 14R to the boom cylinder 7, and discharge the hydraulic oil in the boom cylinder 7 to the hydraulic oil tank.

The control valves 176L and 176R feed the hydraulic oil discharged from the main pumps 14L and 14R to the arm cylinder 8, and discharge the hydraulic oil in the arm cylinder 8 to the hydraulic oil tank.

In accordance with the pilot pressure applied to the pilot port, each of the control valves 171, 172, 173, 174, 175L, 175R, 176L, and 176R adjusts the flow rate of the hydraulic oil to be fed to or discharged from the hydraulic actuator, and switches the flowing direction.

The parallel oil path C2L feeds the hydraulic oil of the main pump 14L to the control valves 171, 173, 175L, and 176L in parallel to the center bypass oil path C1L. Specifically, the parallel oil path C2L branches from the center bypass oil path C1L upstream of the control valve 171, and is configured to feed the hydraulic oil of the main pump 14L to the control valves 171, 173, 175L, and 176R, in parallel. Thereby, when the flow of the hydraulic oil passing through the center bypass oil path C1L is restricted or blocked by any one of the control valves 171, 173, and 175L, the parallel oil path C2L can feed the hydraulic oil to the more downstream control valve.

The parallel oil path C2R feeds the hydraulic oil of the main pump 14R to the control valves 172, 174, 175R, and 176R in parallel to the center bypass oil path C1R. Specifically, the parallel oil path C2R branches from the center bypass oil path C1R upstream of the control valve 172, and is configured to feed the hydraulic oil of the main pump 14R to the control valves 172, 174, 175R, and 176R, in parallel. When the flow of the hydraulic oil passing through the center bypass oil path C1R is restricted or blocked by any one of the control valves 172, 174, and 175R, the parallel oil path C2R can feed the hydraulic oil to the more downstream control valve.

The regulators 13L and 13R adjust the tilting angles of the swashplates of the main pumps 14L and 14R under control by the controller 30, thereby adjusting the discharge amounts of the main pumps 14L and 14R.

The discharge pressure sensor 28L detects the discharge pressure of the main pump 14L, and a detection signal corresponding to the detected discharge pressure is input to the controller 30. The same applies to the discharge pressure sensor 28R. Thereby, the controller 30 can control the regulators 13L and 13R in accordance with the discharge pressures of the main pumps 14L and 14R.

In the center bypass oil paths C1L and C1R, restrictors for negative control (hereinafter referred to as “negative-control restrictors”) 18L and 18R are provided between the most downstream control valves 176L and 176R and the hydraulic oil tank. Thereby, the flow of the hydraulic oil discharged from the main pumps 14L and 14R is restricted by the negative-control restrictors 18L and 18R. The negative-control restrictors 18L and 18R generate control pressures (hereinafter referred to as “negative-control pressures) for controlling the regulators 13L and 13R.

Negative-control pressure sensors 19L and 19R detect the negative-control pressures, and detection signals corresponding to the detected negative-control pressures are input to the controller 30.

In accordance with the discharge pressures of the main pumps 14L and 14R detected by the discharge pressure sensors 28L and 28R, the controller 30 may control the regulators 13L and 13R and adjust the discharge amounts of the main pumps 14L and 14R. For example, in accordance with an increase in the discharge pressure of the main pump 14L, the controller 30 may control the regulator 13L and adjust the tilting angle of the swashplate of the main pump 14L, thereby reducing the discharge amount. The same applies to the regulator 13R. Thereby, the controller 30 can control the total power of the main pumps 14L and 14R so that the suction power of the main pumps 14L and 14R, which is represented by a product of the discharge pressure and the discharge amount, does not exceed the output power of the engine 11.

Also, in accordance with the negative-control pressures detected by the negative-control pressure sensors 19L and 19R, the controller 30 may control the regulators 13L and 13R and adjust the discharge amounts of the main pumps 14L and 14R. For example, the controller 30 reduces the discharge amounts of the main pumps 14L and 14R at higher negative-control pressures, and increases the discharge amounts of the main pumps 14L and 14R at lower negative-control pressures.

Specifically, when the shovel 100 is in a standby state in which all of the hydraulic actuators are not operated (the state as illustrated in FIG. 4), the hydraulic oil discharged from the main pumps 14L and 14R passes through the center bypass oil paths C1L and C1R to reach the negative-control restrictors 18L and 18R. Then, the flow of the hydraulic oil discharged from the main pumps 14L and 14R increases the negative-control pressures generated upstream of the negative-control restrictors 18L and 18R. As a result, the controller 30 reduces the discharge amounts of the main pumps 14L and 14R to allowable minimum discharge amounts, and suppresses pressure loss (pumping loss) when the discharged hydraulic oil passes through the center bypass oil paths C1L and C1R.

Meanwhile, when any one of the hydraulic actuators is operated via the operation device 26, the hydraulic oil discharged from the main pumps 14L and 14R flows into the operated hydraulic actuator via the control valve corresponding to the operated hydraulic actuator. Then, the amount of the flow of the hydraulic oil discharged from the main pumps 14L and 14R that reaches the negative-control restrictors 18L and 18R is reduced or eliminated, resulting in reducing the negative-control pressures generated upstream of the negative-control restrictors 18L and 18R. As a result, the controller 30 increases the discharge amounts of the main pumps 14L and 14R and circulates a sufficient amount of the hydraulic oil in the operated hydraulic actuator. This can reliably drive the operated hydraulic actuator.

Next, referring to FIG. 5A to FIG. 5C, one example of a hydraulic circuit of the operation system, specifically one example of a pilot circuit that applies the pilot pressure to the control valves 174 to 176 related to the movements of the attachments (the boom 4, the arm 5, and the bucket 6) will be described. FIG. 5A to FIG. 5C are each an explanatory view of one example of the pilot circuit.

FIG. 5A to FIG. 5C are views illustrating examples of the configurations of the pilot circuits that apply the pilot pressures to the control valves 17 (control valves 174 to 176) that hydraulically control the hydraulic actuators corresponding to the attachments.

Specifically, FIG. 5A is a view illustrating one example of the pilot circuit that applies the pilot pressure to the control valves (control valves 175L and 175R) that hydraulically control the boom cylinder 7. FIG. 5B is a view illustrating one example of the pilot circuit that applies the pilot pressure to the control valves 176L and 176R that hydraulically control the arm cylinder 8. FIG. 5C is a view illustrating one example of the pilot circuit that applies the pilot pressure to the control valve 174 that hydraulically controls the bucket cylinder 9.

As illustrated in FIG. 5A, the lever device 26A is used for operating the boom cylinder 7 corresponding to the boom 4. In other words, the lever device 26A operates the movement of the boom 4. The lever device 26A utilizes the hydraulic oil discharged from the pilot pump 15, and outputs the pilot pressure in accordance with the operation state to the secondary side.

The two inlet ports of the shuttle valve 32AL are connected respectively to: the pilot line on the secondary side of the lever device 26A corresponding to an operation to move the boom 4 upward (hereinafter referred to as a “boom raising operation”); and the pilot line on the secondary side of the proportional valve 31AL. The outlet port of the shuttle valve 32AL is connected to a right-hand pilot port of the control valve 175L and a left-hand pilot port of the control valve 175R.

The two inlet ports of the shuttle valve 32AR are connected respectively to: the pilot line on the secondary side of the lever device 26A corresponding to an operation to move the boom 4 downward (hereinafter referred to as a “boom lowering operation”); and the pilot line on the secondary side of the proportional valve 31AR. The outlet port of the shuttle valve 32AR is connected to a right-hand pilot port of the control valve 175R.

That is, the lever device 26A applies the pilot pressure in accordance with the operation state to the pilot ports of the control valves 175L and 175R via the shuttle valves 32AL and 32AR. Specifically, when the boom raising operation has been performed on the lever device 26A, the lever device 26A outputs the pilot pressure in accordance with the operation amount to one of the inlet ports of the shuttle valve 32AL, and applies the pilot pressure to the right-hand pilot port of the control valve 175L and the left-hand pilot port of the control valve 175R via the shuttle valve 32AL. Also, when the boom lowering operation has been performed on the lever device 26A, the lever device 26A outputs the pilot pressure in accordance with the operation amount to one of the inlet ports of the shuttle valve 32AR, and applies the pilot pressure to the right-hand pilot port of the control valve 175R via the shuttle valve 32AR.

The proportional valve 31AL operates in accordance with a control current input from the controller 30. Specifically, the proportional valve 31AL utilizes the hydraulic oil discharged from the pilot pump 15, and outputs the pilot pressure in accordance with the control current, which is input from the controller 30, to the other inlet port of the shuttle valve 32AL. Thereby, the proportional valve 31AL can adjust, via the shuttle valve 32AL, the pilot pressure to be applied to the right-hand pilot port of the control valve 175L and the left-hand pilot port of the control valve 175R.

The proportional valve 31AR operates in accordance with a control current input from the controller 30. Specifically, the proportional valve 31AR utilizes the hydraulic oil discharged from the pilot pump 15, and outputs the pilot pressure in accordance with the control current, which is input from the controller 30, to the other inlet port of the shuttle valve 32AR. Thereby, the proportional valve 31AR can adjust, via the shuttle valve 32AR, the pilot pressure to be applied to the right-hand pilot port of the control valve 175R.

That is, regardless of the operation state of the lever device 26A, the proportional valves 31AL and 31AR can adjust the pilot pressure to be output to the secondary side so that the control valves 175L and 175R can stop at given valve positions.

The operation pressure sensor 29A detects, as a pressure, the operation state by the operator on the lever device 26A, and a detection signal corresponding to the detected pressure is input to the controller 30. Thereby, the controller 30 can identify the operation state of the lever device 26A. The operation state can include an operation direction, an operation amount (operation angle), and the like. In the following, the same applies to the lever devices 26B and 26C.

Regardless of the boom raising operation by the operator on the lever device 26A, the controller 30 can feed the hydraulic oil discharged from the pilot pump 15 to the right-hand pilot port of the control valve 175L and the left-hand pilot port of the control valve 175R via the proportional valve 31AL and the shuttle valve 32AL.

Also, regardless of the boom lowering operation by the operator on the lever device 26A, the controller 30 can feed the hydraulic oil discharged from the pilot pump 15 to the right-hand pilot port of the control valve 175R via the proportional valve 31AR and the shuttle valve 32AR. That is, the controller 30 can automatically control the upward-downward movement of the boom 4.

As illustrated in FIG. 5B, the lever device 26B is used for operating the arm cylinder 8 corresponding to the arm 5. In other words, the lever device 26B operates the movement of the arm 5. The lever device 26B utilizes the hydraulic oil discharged from the pilot pump 15, and outputs the pilot pressure in accordance with the operation state to the secondary side.

The two inlet ports of the shuttle valve 32BL are connected respectively to: the pilot line on the secondary side of the lever device 26B corresponding to an operation to move the arm 5 in a closing direction (hereinafter referred to as an “arm closing operation”); and the pilot line on the secondary side of the proportional valve 31BL. The outlet port of the shuttle valve 32BL is connected to the right-hand pilot port of the control valve 176L and the left-hand pilot port of the control valve 176R.

The two inlet ports of the shuttle valve 32BR are connected respectively to: the pilot line on the secondary side of the lever device 26B corresponding to an operation to move the arm 5 in an opening direction (hereinafter referred to as an “arm opening operation”); and the pilot line on the secondary side of the proportional valve 31BR. The outlet port of the shuttle valve 32BR is connected to the left-hand pilot port of the control valve 176L and the right-hand pilot port of the control valve 176R.

That is, the lever device 26B applies the pilot pressure in accordance with the operation state to the pilot ports of the control valves 176L and 176R via the shuttle valves 32BL and 32BR. Specifically, when the arm closing operation has been performed on the lever device 26B, the lever device 26B outputs the pilot pressure in accordance with the operation amount to one of the inlet ports of the shuttle valve 32BL, and applies the pilot pressure to the right-hand pilot port of the control valve 176L and the left-hand pilot port of the control valve 176R via the shuttle valve 32BL.

Also, when the arm opening operation has been performed on the lever device 26B, the lever device 26B outputs the pilot pressure in accordance with the operation amount to one of the inlet ports of the shuttle valve 32BR, and applies the pilot pressure to the left-hand pilot port of the control valve 176L and the right-hand pilot port of the control valve 176R via the shuttle valve 32BR.

The proportional valve 31BL operates in accordance with a control current input from the controller 30. Specifically, the proportional valve 31BL utilizes the hydraulic oil discharged from the pilot pump 15, and outputs the pilot pressure in accordance with the control current, which is input from the controller 30, to the other pilot port of the shuttle valve 32BL. Thereby, the proportional valve 31BL can adjust, via the shuttle valve 32BL, the pilot pressure to be applied to the right-hand pilot port of the control valve 176L and the left-hand pilot port of the control valve 176R.

The proportional valve 31BR operates in accordance with a control current input from the controller 30. Specifically, the proportional valve 31BR utilizes the hydraulic oil discharged from the pilot pump 15, and outputs the pilot pressure in accordance with the control current, which is input from the controller 30, to the other pilot port of the shuttle valve 32BR. Thereby, the proportional valve 31BR can adjust, via the shuttle valve 32BR, the pilot pressure to be applied to the left-hand pilot port of the control valve 176L and the right-hand pilot port of the control valve 176R.

That is, regardless of the operation state of the lever device 26B, the proportional valves 31BL and 31BR can adjust the pilot pressure to be output to the secondary side so that the control valves 176L and 176R can stop at given valve positions.

The operation pressure sensor 29B detects, as a pressure, the operation state by the operator on the lever device 26B, and a detection signal corresponding to the detected pressure is input to the controller 30. Thereby, the controller 30 can identify the operation state of the lever device 26B.

Regardless of the arm closing operation by the operator on the lever device 26B, the controller 30 can feed the hydraulic oil discharged from the pilot pump 15 to the right-hand pilot port of the control valve 176L and the left-hand pilot port of the control valve 176R via the proportional valve 31BL and the shuttle valve 32BL.

Also, regardless of the arm opening operation by the operator on the lever device 26B, the controller 30 can feed the hydraulic oil discharged from the pilot pump 15 to the left-hand pilot port of the control valve 176L and the right-hand pilot port of the control valve 176R via the proportional valve 31BR and the shuttle valve 32BR. That is, the controller 30 can automatically control the opening-closing movement of the arm 5.

As illustrated in FIG. 5C, the lever device 26C is used for operating the bucket cylinder 9 corresponding to the bucket 6. In other words, the lever device 26C operates the movement of the bucket 6. The lever device 26C utilizes the hydraulic oil discharged from the pilot pump 15, and outputs the pilot pressure in accordance with the operation state to the secondary side.

The two inlet ports of the shuttle valve 32CL are connected respectively to: the pilot line on the secondary side of the lever device 26C corresponding to an operation to move the bucket 6 in a closing direction (hereinafter referred to as a “bucket closing operation”); and the pilot line on the secondary side of the proportional valve 31CL. The outlet port of the shuttle valve 32CL is connected to the left-hand pilot port of the control valve 174.

The two inlet ports of the shuttle valve 32AR are connected respectively to: the pilot line on the secondary side of the lever device 26C corresponding to an operation to move the bucket 6 in an opening direction (hereinafter referred to as a “bucket opening operation”); and the pilot line on the secondary side of the proportional valve 31CR. The outlet port of the shuttle valve 32AR is connected to the right-hand pilot port of the control valve 174.

That is, the lever device 26C applies the pilot pressure in accordance with the operation state to the pilot port of the control valve 174 via the shuttle valves 32CL and 32CR. Specifically, when the bucket closing operation has been performed on the lever device 26C, the lever device 26C outputs the pilot pressure in accordance with the operation amount to one of the inlet ports of the shuttle valve 32CL, and applies the pilot pressure to the left-hand pilot port of the control valve 174 via the shuttle valve 32CL.

Also, when the bucket opening operation has been performed on the lever device 26C, the lever device 26C outputs the pilot pressure in accordance with the operation amount to one of the inlet ports of the shuttle valve 32CR, and applies the pilot pressure to the right-hand pilot port of the control valve 174 via the shuttle valve 32CR.

The proportional valve 31CL operates in accordance with a control current input from the controller 30. Specifically, the proportional valve 31CL utilizes the hydraulic oil discharged from the pilot pump 15, and outputs the pilot pressure in accordance with the control current, which is input from the controller 30, to the other pilot port of the shuttle valve 32CL. Thereby, the proportional valve 31CL can adjust, via the shuttle valve 32CL, the pilot pressure to be applied to the left-hand pilot port of the control valve 174.

The proportional valve 31CR operates in accordance with a control current input from the controller 30. Specifically, the proportional valve 31CR utilizes the hydraulic oil discharged from the pilot pump 15, and outputs the pilot pressure in accordance with the control current, which is input from the controller 30, to the other pilot port of the shuttle valve 32CR. Thereby, the proportional valve 31CR can adjust, via the shuttle valve 32CR, the pilot pressure to be applied to the right-hand pilot port of the control valve 174.

That is, regardless of the operation state of the lever device 26C, the proportional valves 31CL and 31CR can adjust the pilot pressure to be output to the secondary side so that the control valve 174 can stop at a given valve position.

The operation pressure sensor 29C detects, as a pressure, the operation state by the operator on the lever device 26C, and a detection signal corresponding to the detected pressure is input to the controller 30. Thereby, the controller 30 can identify the operation state of the lever device 26C.

Regardless of the bucket closing operation by the operator on the lever device 26C, the controller 30 can feed the hydraulic oil discharged from the pilot pump 15 to the left-hand pilot port of the control valve 174 via the proportional valve 31CL and the shuttle valve 32CL. Also, regardless of the bucket opening operation by the operator on the lever device 26C, the controller 30 can feed the hydraulic oil discharged from the pilot pump 15 to the right-hand pilot port of the control valve 174 via the proportional valve 31CR and the shuttle valve 32CR. That is, the controller 30 can automatically control the opening-closing movement of the bucket 6.

Note that, the shovel 100 may include a structure that automatically swivels the upper swiveling body 3. In this case, also for the pilot circuit that applies the pilot pressure to the control valve 173, the hydraulic system similar to FIG. 5A to FIG. 5C, including the proportional valve 31 and the shuttle valve 32, is employed. Also, the shovel 100 may include a structure that automatically moves the lower traveling body 1 forward and backward.

In this case, also for the pilot circuit that applies the pilot pressure to the control valves 171 and 172 corresponding to the traveling hydraulic motors 1L and 1R, the hydraulic system similar to FIG. 5A to FIG. 5C, including the proportional valve 31 and the shuttle valve 32, is employed. Also, although the hydraulic pilot circuit is employed in the operation device 26 (lever devices 26A to 26C) as described above, an electrical operation device 26 (lever devices 26A to 26C) including an electrical pilot circuit rather than the hydraulic pilot circuit may be employed.

In this case, the operation amount of the electrical operation device 26 is input to the controller 30 as an electrical signal. Also, an electromagnetic valve is disposed between the pilot pump 15 and the pilot port of each control valve. The electromagnetic valve is configured to operate in accordance with an electrical signal from the controller 30. With this configuration, in response to a manual operation using the electrical operation device 26, the controller 30 controls the electromagnetic valve based on the electrical signal corresponding to the operation amount and increases or decreases the pilot pressure, and thereby can move each of the control valves (control valves 171 to 176).

Also, each of the control valves (control valves 171 to 176) may be formed of an electromagnetic spool valve. In this case, the electromagnetic spool valve moves in accordance with an electrical signal, from the controller 30, corresponding to the operation amount of the electrical operation device 26.

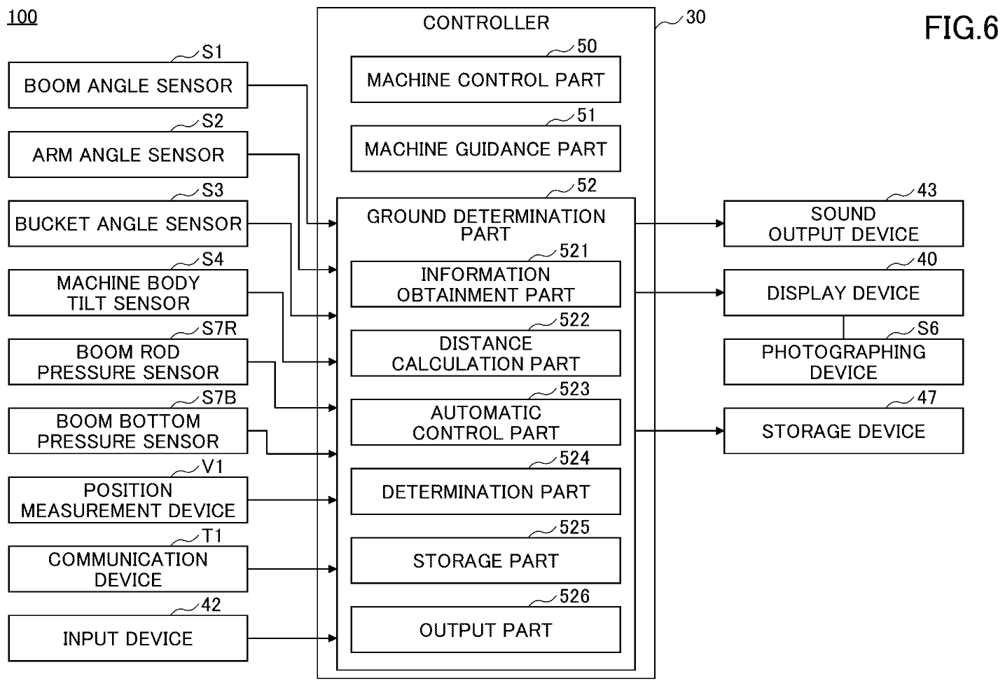

Next, referring to FIG. 6, the functions of the controller 30 of the shovel 100 will be described. FIG. 6 is an explanatory view of the functions of the controller of the shovel. For example, the controller 30 realizes the functions of the below-described parts by executing one or more programs on the CPU that are stored in the ROM or the non-volatile auxiliary storage device.

The controller 30 of the present embodiment includes the machine control part 50, the machine guidance part 51, and the ground determination part 52.

For example, when the operator manually performs an excavation operation, the machine control part 50 may automatically operate the boom 4, the arm 5, the bucket 6, or any combination thereof so that the target construction surface matches the position of the front end of the bucket 6.

Also, the machine control part 50 obtains information from, for example, the boom angle sensor S1, the arm angle sensor S2, the bucket angle sensor S3, the machine body tilt sensor S4, the swiveling state sensor S5, the photographing device 80, the position measurement device V1, the communication device T1, and the input device 42.

Then, for example, based on the obtained information, the machine control part 50 calculates the distance between the bucket 6 and the target construction surface, notifies the operator of the extent of the distance between the bucket 6 and the target construction surface from a sound from the sound output device 43 and an image displayed on the display device 40, and automatically controls the movements of the attachments so that the front-end portion of the attachment (bucket 6) matches the target construction surface.

For example, the machine guidance part 51 notifies the operator of work information such as the distance between the target construction surface and the front-end portion of the attachment (specifically, the bucket 6) via the display device 40, the sound output device 43, or the like. For example, the data in relation to the target construction surface are previously stored in the storage device 47 as described above.

The data in relation to the target construction surface are, for example, expressed in a reference coordinate system. The reference coordinate system is, for example, the world geodetic system. The world geodetic system is a three-dimensional orthogonal XYZ coordinate system in which the origin is set at the center of gravity of the globe, the X axis is taken in a direction toward the intersection between the Greenwich meridian and the equator, the Y axis is taken in a direction at 90 degrees of the east longitude, and the Z axis is taken in a direction toward the North Pole.

The operator sets a given point of the construction site, as a reference point. Through the input device 42, the operator sets, as a ground situation determination surface, the target construction surface that has been set from a relative positional relationship to the reference point. Then, the operator can utilize the ground situation determination surface for determining whether the ground is soft. The front-end portion of the attachment serving as the working portion is the blade tip of the bucket 6, the back surface of the bucket 6, or the like. The machine guidance part 51 notifies the operator of the work information through the display device 40, the sound output device 43, or the like, and guides the operation of the shovel 100 by the operator through the operation device 26. The operator may set, as the ground situation determination surface, a ground surface in contact with the shovel 100, i.e., a surface (the ground) with which the crawlers of the lower traveling body 1 are brought into contact. Also, the operator may set, as the ground situation determination surface, a surface located deep by a predetermined distance under the ground surface in contact with the shovel 100. Also, the ground situation determination surface may be set by the manager rather than the operator.

The ground determination part 52 performs an operation to touch the ground with the back surface of the bucket 6 every time the shovel 100 moves by a predetermined distance. The predetermined distance may be a distance from the current position of the shovel 100 to a region touched with the back surface of the bucket 6.

This operation may be performed while the shovel 100 is autonomously traveling. The controller 30 of the present embodiment performs this operation, and thereby determines the presence or absence of the soft ground region (muddy region) in the traveling direction of the shovel 100.

Note that, the operation to touch the ground with the back surface of the bucket 6 is similar to a compaction operation to press the back surface (working portion) of the bucket 6 (end attachment) against the ground and apply a predetermined compaction force to the ground. Therefore, the operation to determine the presence or absence of the soft ground region in the present embodiment can also be referred to as the compaction operation performed every time the shovel 100 travels by the predetermined distance. Also, in the following description, the soft ground region may be referred to as the muddy region.

In this way, the shovel 100 of the present embodiment determines the presence or absence of the soft ground region in the traveling direction, and permits the shovel 100 to move in the traveling direction in response to determining the absence of the soft ground region. Therefore, according to the present embodiment, it is possible to avoid entry into the soft ground region.

In the following, the ground determination part 52 will be further described. The ground determination part 52 of the present embodiment includes an information obtainment part 521, a distance calculation part 522, an automatic control part 523, a determination part 524, a storage part 525, and an output part 526.

The information obtainment part 521 obtains various information. Specifically, the information obtainment part 521 obtains, for example, information indicating the position of the shovel 100 (position information). The position information of the present embodiment may be obtained by, for example, a GPS (Global Positioning System) function of the shovel 100. Also, the position information of the shovel 100 may be calculated from position information of a plurality of objects that can be references in, for example, the construction site where the shovel 100 works.

Also, for example, the information obtainment part 521 may calculate a coordinate point in the reference coordinate system of the front-end portion of the attachment (bucket 6). Specifically, the information obtainment part 521 may calculate the coordinate point of the blade tip of the bucket 6 from the elevation and depression angles of the boom 4, the arm 5, and the bucket 6 (the boom angle, the arm angle, and the bucket angle).

Also, for example, when the shovel 100 communicates with a construction management device that manages the construction site, the information obtainment part 521 may obtain, from the construction management device, route information indicating a route of the shovel 100 to the destination.

Also, for example, the information obtainment part 521 may obtain image data taken by the photographing device 80 as information used for determining the presence or absence of the soft ground region.

The distance calculation part 522 calculates a movement distance of the shovel 100. Specifically, the distance calculation part 522 calculates the movement distance of the shovel 100 based on the position information obtained by the information obtainment part 521. Note that, the distance calculation part 522 may calculate the vertical distance between the front-end portion of the bucket 6 serving as the working portion (e.g., the blade tip or the back surface) and the ground situation determination surface.

The automatic control part 523 automatically operates the actuator and thereby automatically assists a manual operation of the shovel 100 by the operator through the operation device 26.

For example, in order to assist excavation, the automatic control part 523 automatically stretches or contracts the boom cylinder 7, the arm cylinder 8, the bucket cylinder 9, or any combination thereof. Specifically, when the operator manually performs the arm closing operation, the automatic control part 523 automatically stretches or contracts the boom cylinder 7, the arm cylinder 8, the bucket cylinder 9, or any combination thereof so that the ground situation determination surface matches the position of the blade tip of the bucket 6.

In this case, for example, only by performing the arm closing operation of the lever device 26B, the operator can close the arm 5 while matching the blade tip of the bucket 6 with the ground situation determination surface. The automatic control may be performed when a predetermined switch included in the input device 42 is pushed. The predetermined switch is, for example, a machine control switch (hereinafter referred to as a “MC (Machine Control) switch”) and may be disposed, as a knob switch, at the front end of a grip portion of the operation device 26 (lever devices 26A to 26C) that is taken hold of by the operator. Thereby, the operator can confirm the situation of the ground in front of the shovel 100.

The automatic control part 523 may automatically rotate the swiveling hydraulic motor 2A in order to make the upper swiveling body 3 face the ground situation determination surface. In this case, only by pushing a predetermined switch included in the input device 42, the operator can make the upper swiveling body 3 face the ground situation determination surface. Alternatively, only by pushing a predetermined switch included in the input device 42, the operator can make the upper swiveling body 3 face the ground situation determination surface and start the machine control function. Thereby, the operator can confirm the situation of the ground around the shovel 100.

The automatic control part 523 individually and automatically adjusts the pilot pressure to be applied to the control valves corresponding to the respective hydraulic actuators, and thereby can automatically operate the respective hydraulic actuators.

Also, the automatic control part 523 of the present embodiment assists the compaction operation by the shovel 100 every time the distance calculated by the distance calculation part 522 is the predetermined distance. Details of the assist of the compaction operation by the automatic control part 523 will be described below.

The determination part 524 determines the presence or absence of the soft ground region in the compacted region based on the result obtained by the compaction operation performed by the automatic control part 523.

Specifically, in a case where when the back surface of the bucket 6 is pressed against the ground at a predetermined pressing force (target pressure) in the compaction operation, the back surface of the bucket 6 has sunk in the ground surface in contact with the crawlers by the predetermined distance or greater, the determination part 524 may determine that the ground region in contact with the back surface of the bucket 6 is the soft ground region.

Also, in a case where when the back surface of the bucket 6 is pressed against the ground in the compaction operation with the ground situation determination surface being set to a position under the ground surface in contact with the crawlers by the predetermined distance, the back surface of the bucket 6 has reached the ground situation determination surface, the determination part 524 may determine that this region is the soft ground region by regarding the ground surface to have sunk.

Any one of the above-described two methods may be used as a method for determination in the determination part 524 of the present embodiment.

The storage part 525 stores (reserves) various information in relation to the machine guidance function and the machine control function. For example, the storage part 525 stores various set values in relation to the machine guidance function and the machine control function. Also, for example, the storage part 525 stores (reserves) a targeted compaction force in the compaction operation (hereinafter referred to as a “target compaction force”).

Furthermore, the storage part 525 of the present embodiment may store the position information indicating the position of a region on which the compaction operation has been performed, the determination result obtained by the determination part 524, and the image data obtained by the photographing device 80, with the position information, the determination result, and the image data being associated with each other.

The position information of the region on which the compaction operation has been performed may be, for example, a coordinate point of the blade tip of the bucket 6 calculated from the boom angle, the arm angle, and the bucket angle.

Also, the storage part 525 may store position information of a plurality of objects to become references that are referred to when the information obtainment part 521 obtains the position information of the shovel 100.

Note that, the contents stored in the storage part 525 may be stored (reserved) in the storage device 47 that is external with respect to the controller 30.

The output part 526 transmits, to the operator of the shovel 100 (notifies the operator of the shovel 100 of), various information through predetermined notification means such as the display device 40 and the sound output device 43. The output part 526 notifies the operator of the determination result obtained by the determination part 524. Specifically, the output part 526 uses visual information provided by the display device 40, audio information provided by the sound output device 43, or both thereof, thereby notifying the operator of the presence or absence of the soft ground region in the traveling direction.

For example, the output part 526 uses the sound output device 43 to notify the operator of the presence or absence of the soft ground region in the traveling direction. In this case, when the presence of the soft ground region in the traveling direction is determined, the output part 526 may stop the shovel 100 and output a warning sound.

Also, the output part 526 may transmit, to the construction management device for managing the construction site, the various information obtained by the information obtainment part 521 and the determination result obtained by the determination part 524.

The information transmitted to the construction management device includes the position information of the shovel 100, the image data obtained by the photographing device 80, the position information of the region on which the compaction operation has been performed, and the information indicating the determination result obtained by the determination part 524. These items of information may be shared by the construction management device with other shovels 100 that work in the same construction site as the shovel 100.

Next, the assist of the compaction operation by the automatic control part 523 of the present embodiment will be described.

In the present embodiment, for example, the automatic control part 523 automatically stretches or contracts the boom cylinder 7, the arm cylinder 8, the bucket cylinder 9, or any combination thereof for assisting the compaction operation. The compaction operation allows for an operation to apply a predetermined compaction force to the ground by pressing the back surface of the bucket 6 against the ground.

For example, when the operator manually operates the boom lowering operation, the automatic control part 523 automatically stretches or contracts the boom cylinder 7, the arm cylinder 8, the bucket cylinder 9, or any combination thereof. Thereby, the automatic control part 523 presses the back surface of the bucket 6 against the ground (horizontal surface) at a predetermined pressing force, thereby applying the predetermined pressing force to the ground.

At this time, the automatic control part 523 adjusts the posture of the attachment so that a relatively flat portion of the back surface of the bucket 6 touches the ground, the relatively flat portion being flat with respect to the ground. Specifically, when the front-end portion of the attachment (bucket 6) is pressed against the ground, the automatic control part 523 adjusts the attachment to take a predetermined posture optimum for the compaction operation.

In the present embodiment, by assisting the compaction operation in this manner, a curved surface portion of the back surface of the bucket 6 does not contact the ground, differing from the compaction operation that is manually performed in a conventional manner. It is thus possible to suppress occurrence of a circumstance where the surface pressure received by the back surface of the bucket 6 from the ground changes and the compaction force applied by the bucket 6 to the ground also changes.

The automatic control in relation to the compaction operation (hereinafter referred to as a “compaction assist control”) is performed in response to, for example, pushing of a predetermined switch such as a compaction assist control-related dedicated switch included in the input device 42 (hereinafter referred to as a “compaction assist control switch”). Also, the compaction assist control may be performed in response to operating of the predetermined operation device 26 with the predetermined switch being pushed.

In this case, when the boom lowering operation is performed through the operation device 26 (lever device 26A) with the compaction assist control switch being pushed, the automatic control part 523 automatically contacts the back surface of the bucket 6 with the ground situation determination surface. Specifically, the automatic control part 523 controls the arm 5 and the bucket 6 so that the flat portion of the back surface of the bucket 6, which is the working portion, contacts the ground situation determination surface in parallel thereto, along with a boom lowering movement.

When from that state, the boom lowering operation is performed through the operation device 26 (lever device 26A), further, the automatic control part 523 automatically starts the compaction operation by pressing the flat portion of the back surface of the bucket 6 against the ground while maintaining the posture of the flat portion of the back surface of the bucket 6. At this time, the automatic control part 523 (specifically, a posture state determination portion 542 as described below) determines the posture of the attachment. This is because as described below, the pressing force applied from the bucket 6 to the ground could change in accordance with the posture of the attachment even if the cylinder pressure of the boom cylinder 7 is the same.

Therefore, upon pressing the bucket 6 against the ground (upon the compaction operation), the automatic control part 523 controls the cylinder pressure of the boom cylinder 7 in accordance with the posture of the attachment, and thereby generates a preset compaction force even if the posture of the attachment changes.

Also, the compaction assist control may be automatically started when the compaction operation of the shovel 100 is performed (started). In this case, the controller 30 may automatically start the compaction assist control when the next operation is predicted based on, for example, the tendency of the operator to operate the operation device 26 and the surrounding situation of the shovel 100 that can be determined based on the photographed image of the photographing device 80, and the predicted operation is the compaction operation.

In this way, in the present embodiment, when the boom lowering operation has been performed, the predetermined compaction force is applied to the ground by pressing the flat portion of the back surface of the bucket 6 against the ground in the vertical direction to the ground situation determination surface while maintaining the posture of the flat portion of the back surface of the bucket 6. In the present embodiment, at this time, when the back surface of the bucket 6 has sunk relative to the ground surface in contact with the crawlers by the predetermined distance or greater, the ground region in contact with the flat portion of the back surface of the bucket 6 is determined to be the soft ground region.

Also, in the present embodiment, when the ground surface has sunk by pressing of the bucket 6 and the back surface of the bucket 6 has reached the ground situation determination surface under the ground surface in contact with the crawlers by the predetermined distance, the ground region in contact with the flat portion of the back surface of the bucket 6 is determined to be the soft ground region.

At this time, the controller 30 can identify a site that has undergone the compaction by the shovel 100, using posture sensors such as the position measurement device V1, the boom angle sensor S1, the arm angle sensor S2, and the bucket angle sensor S3. Therefore, the controller 30 can also generate and display combined information on the display device 40, the combined information being obtained by mapping sites where the compaction operation has been completed, on the geographical information that is previously stored in, for example, the storage device 47. Also, the controller 30 may generate combined information by mapping, on the geographical information, sites where the ground surfaces are lower than the target height, and display the combined information on the display device 40. Thereby, the operator can come to know the progress of the compaction operation and banking work.

Also, when the compaction operation has been completed in the to-be-compacted region that is previously set through, for example, the input device 42, the automatic control part 523 may output, to the operator, a notification indicating the presence or absence of the soft ground region through, for example, the display device 40 and the sound output device 43. Thereby, the operator can come to know the presence or absence of the soft ground region from this notification. Also, the automatic control part 523 may determine whether the compaction operation of the to-be-compacted region has been completed, based on, for example, the photographed image taken by the photographing device 80.

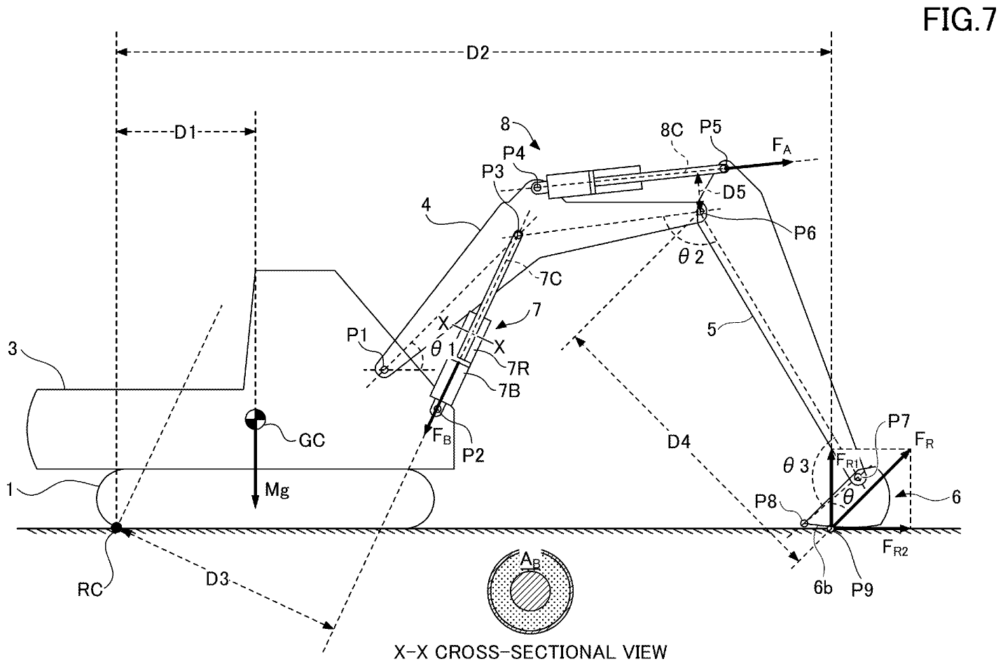

Next, referring to FIG. 7, a calculation method by the controller 30 for a work reaction force on which the compaction assist control is based will be described.

FIG. 7 is a schematic view illustrating a relationship between forces applied to the shovel (attachment) upon the compaction operation.

In the compaction operation, when the shovel 100 moves the front-end portion of the attachment, specifically, the back surface of the bucket 6 along the ground situation determination surface so that the geographical feature becomes the same as the feature of the ground situation determination surface, the shovel 100 drives the boom 4 upward and downward in response to the closing movement of the arm 5. At this time, a boom thrust occurring during the lowering movement of the boom 4 is transmitted to the ground surface as the compaction force.

This is why a relationship between forces when the boom thrust is transmitted to the ground surface will be specifically described.

In FIG. 7, point P1 indicates a connection point between the upper swiveling body 3 and the boom 4, and point P2 indicates a connection point between the upper swiveling body 3 and the cylinder of the boom cylinder 7. Also, point P3 indicates a connection point between a rod 7C of the boom cylinder 7 and the boom 4, and point P4 indicates a connection point between the boom 4 and the cylinder of the arm cylinder 8.

Also, point P5 indicates a connection point between a rod 8C of the arm cylinder 8 and the arm 5, and point P6 indicates a connection point between the boom 4 and the arm 5. Also, point P7 indicates a connection point between the arm 5 and the bucket 6, point P8 indicates the front end of the bucket 6, and point P9 indicates a predetermined point in a back surface 6b of the bucket 6.

Note that, in FIG. 7, for simplicity, the bucket cylinder 9 is not illustrated.

Also, in FIG. 7, an angle between the horizontal line and a straight line connecting the point P1 to the point P3 is indicated by a boom angle 91, an angle between a straight line connecting the point P3 to the point P6 and a straight line connecting the point P6 to the point P7 is indicated by an arm angle 92, and an angle between the straight line connecting the point P6 to the point P7 and a straight line connecting the point P7 to the point P8 is indicated by a bucket angle 93.

Furthermore, in FIG. 7, distance D1 indicates a horizontal distance between rotation center RC upon occurrence of rising of the machine body and the center of gravity GC of the shovel 100, i.e., a distance between the rotation center RC and a line of action of gravity M·g, which is a product of mass M of the shovel 100 and gravitational acceleration g. The product of the distance D1 and the magnitude of the gravity M·g represents a magnitude of the moment of a first force around the rotation center RC.

Note that, the symbol “·” means being multiplied.

The position of the rotation center RC is, for example, determined based on the output of the swiveling state sensor S5. For example, when the swiveling angle between the lower traveling body 1 and the upper swiveling body 3 is 0 degrees, the rotation center RC is the back end of the contact portion of the lower traveling body 1 with the ground surface in contact therewith, and when the swiveling angle between the lower traveling body 1 and the upper swiveling body 3 is 180 degrees, the rotation center RC is the front end of the contact portion of the lower traveling body 1 with the ground surface in contact therewith. Also, when the swiveling angle between the lower traveling body 1 and the upper swiveling body 3 is 90 degrees or 270 degrees, the rotation center RC is the side end of the contact portion of the lower traveling body 1 with the ground surface in contact therewith.

Also, in FIG. 7, distance D2 indicates a horizontal distance between the rotation center RC and the point P9, i.e., a distance between the rotation center RC and a line of action of a component FR1, of a work reaction force FR, that is vertical to the ground (in the present example, the horizontal surface) (hereinafter referred to as a “vertical component”). Also, a component FR2 of the work reaction force FR is a component, of the work reaction force FR, that is parallel to the ground. The product of the distance D2 and the magnitude of the vertical component FR1 represents a magnitude of the moment of a second force around the rotation center RC.

In the present example, the work reaction force FR forms a work angle θ with respect to the vertical axis, and the vertical component FR1 of the work reaction force FR is presented as FR1=FR·cos θ. Also, the work angle θ is calculated based on the boom angle θ1, the arm angle θ2, and the bucket angle θ3. The ground is pressed against the ground situation determination surface in the vertical direction at a force corresponding to the vertical component FR1 of the work reaction force FR.

That is, the vertical component FR1 of the work reaction force FR corresponds to a pressing force against the ground by the back surface of the bucket 6 upon the compaction operation. A component FR2 of the work reaction force FR parallel to the ground (hereinafter referred to as a “parallel component”) does not generate a great force upon the compaction operation. Upon the compaction operation described in the present embodiment, the vertical component FR1 of the work reaction force FR becomes a greater force than the parallel component FR2.

Also, in FIG. 7, distance D3 indicates a distance between a straight line connecting the point P2 to the point P3 and the rotation center RC, i.e., a distance between the rotation center RC and a line of action of a force FB to contract the rod 7C of the boom cylinder 7 into the cylinder by the hydraulic oil fed to the rod-side oil chamber of the boom cylinder 7. The product of the distance D3 and the magnitude of the force FB represents a magnitude of the moment of a third force around the rotation center RC. In the present example, the force FB to contract the rod 7C of the boom cylinder 7 into the cylinder is attributed to the work reaction force FR applied to the point P9 by the back surface 6b of the bucket 6.

Also, in FIG. 7, distance D4 indicates a distance between a line of action of the work reaction force FR and the point P6. The product of the distance D4 and the magnitude of the work reaction force FR represents a magnitude of the moment of a first force around the point P6.

Also, in FIG. 7, distance D5 indicates a distance between a straight line connecting the point P4 to the point P5 and the point P6, i.e., a distance between the point P6 and a line of action of an arm thrust FA to close the arm 5. The product of the distance D5 and the magnitude of the arm thrust FA represents a magnitude of the moment of a second force around the point P6.

Assuming that the magnitude of the moment of a force for the vertical component FR1 of the work reaction force FR to raise the shovel 100 around the rotation center RC is replaceable with the magnitude of the moment of a force for the force FB, which is to contract the rod 7C of the boom cylinder 7 into the cylinder, to raise the shovel around the rotation center RC, a relationship between the magnitude of the moment of the second force around the rotation center RC and the magnitude of the moment of the third force around the rotation center RC is expressed by the following formula (1).

FR1·D2=FR·cos θ·D2=FB·D3 (1)

Furthermore, as illustrated in an X-X cross-sectional view of FIG. 7, when an annular pressure-receiving area of a piston facing a rod-side oil chamber 7R of the boom cylinder 7 is denoted by area AB and a pressure of the hydraulic oil in the rod-side oil chamber 7R is denoted by a boom rod pressure PB, the force FB to contract the rod 7C of the boom cylinder 7 into the cylinder is expressed by FB=PB·AB. Therefore, the formula (1) is expressed by the following formula (2).

Note that, the symbol “/” means being divided. Also, the boom rod pressure PB can be measured based on the output of the boom rod pressure sensor S7R.

PB=FR1·D2/(AB·D3) (2)

Also, the distance D1 is a constant, and the distances D2 to D5 are, similar to the work angle θ, values that are determined in accordance with the postures of the attachments for excavation, i.e., the boom angle θ1, the arm angle θ2, and the bucket angle θ3. Specifically, the distance D2 is determined in accordance with the boom angle θ1, the arm angle θ2, and the bucket angle θ3, the distance D3 is determined in accordance with the boom angle θ1, the distance D4 is determined in accordance with the bucket angle θ3, and the distance D5 is determined in accordance with the arm angle θ2.

In this way, the controller 30 can calculate the work reaction force FR using the above calculation formulae and a calculation map based on the calculation formulae. Also, the controller 30 calculates the work reaction force FR during the compaction operation of the shovel 100, and thereby can calculate the magnitude of the vertical component FR1 of the work reaction force FR as a magnitude of the pressing force.

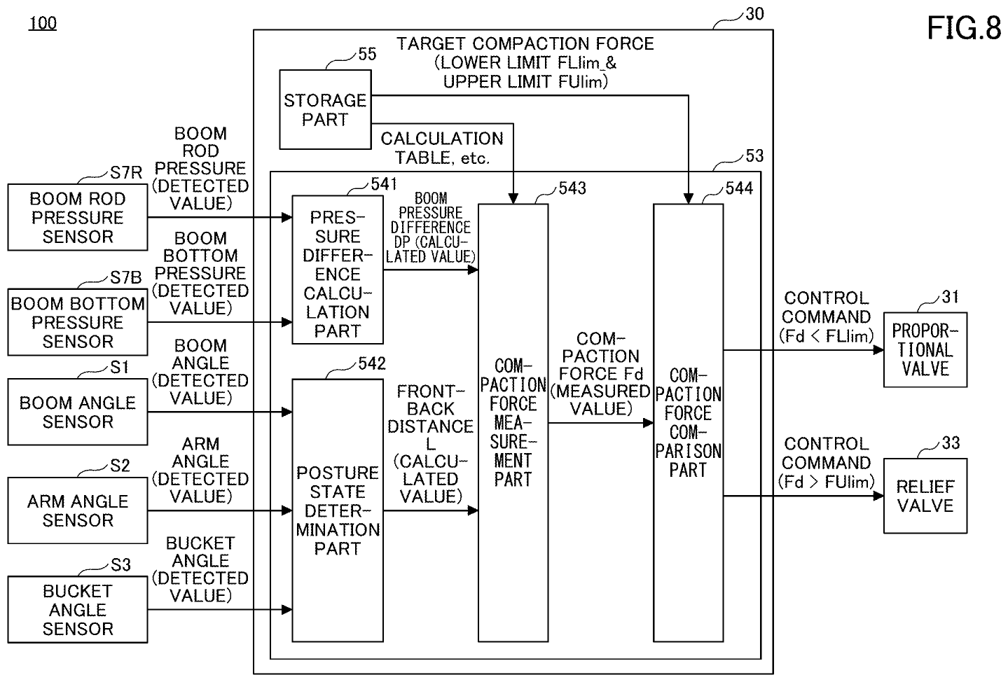

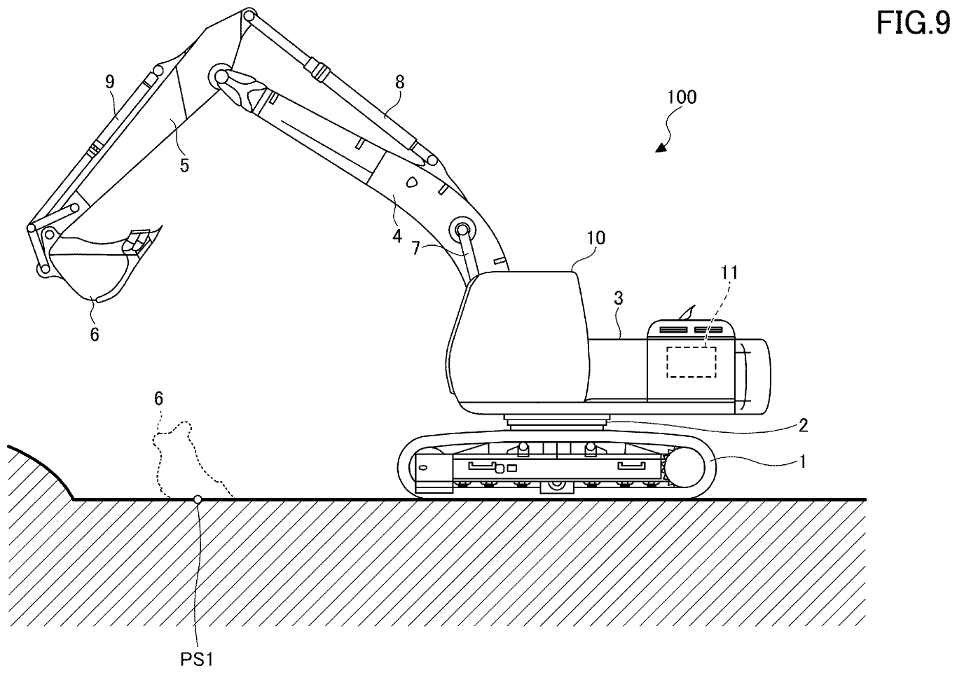

Next, referring to FIG. 8 and FIG. 9, the compaction assist control by the controller 30 (automatic control part 523) will be described.

FIG. 8 is a functional block diagram illustrating a functional configuration in relation to the compaction assist control by the controller. FIG. 9 is one example illustrating a situation of the compaction operation by the shovel 100.

As illustrated in FIG. 8, the automatic control part 523 includes, as functional configurations in relation to the compaction assist control: a pressure difference calculation part 541; a posture state determination part 542; a compaction force measurement part 543; and a compaction force comparison part 544.

The pressure difference calculation part 541 calculates a pressure difference DP between the boom rod pressure and the boom bottom pressure (hereinafter referred to as a “boom pressure difference”) based on the detected values of the boom rod pressure and the boom bottom pressure that are input from the boom rod pressure sensor S7R and the boom bottom pressure sensor S7B.

The posture state determination part 542 determines a posture state of the attachment based on the detected values of the boom angle, the arm angle, and the bucket angle that are input from the boom angle sensor S1, the arm angle sensor S2, and the bucket angle sensor S3 (each of which is one example of a posture detection part). For example, the posture state determination part 542 calculates the front-end portion of the bucket 6 determined by the posture state of the attachment, specifically position information of the predetermined point of the back surface of the bucket 6 that contacts the ground. More specifically, the posture state determination part 542 may calculate a front-back distance L of the bucket 6.

The compaction force measurement part 543 calculates (measures) the compaction force Fd that is being applied to the ground from the bucket 6, based on the boom pressure difference DP and the front-back distance L that are calculated by the pressure difference calculation part 541 and the posture state determination part 542.

Since the work reaction force is, as described above, attributed to the force to contract the rod 7C of the boom cylinder 7 into the cylinder by the hydraulic oil fed to the rod-side oil chamber of the boom cylinder 7, the greater the boom pressure difference DP, the greater the vertical component of the work reaction force, i.e., the compaction force Fd applied to the ground from the bucket 6.

Also, the compaction force Fd applied to the ground from the bucket 6 changes in accordance with the posture of the attachment even if the boom pressure difference is identical.

Note that, a contour line of the compaction force in relation to the boom pressure difference DP and the front-back distance L can be non-linear. Also, the compaction force measurement part 543 may utilize, instead of the boom pressure difference, a calculation (measurement) value of the arm thrust or excavation reaction force as a compaction force-related force to be applied to the shovel 100. Also, the compaction force measurement part 543 may utilize other posture information of the attachment instead of the front-back distance L of the bucket 6.

The compaction force measurement part 543 calculates the compaction force Fd based on information indicating a relationship of the boom pressure difference DP, the front-back distance L, and the compaction force Fd (e.g., a calculation formula, a calculation map, and a calculation table) stored in the storage part 525.

The compaction force comparison part 544 compares the compaction force Fd measured by the compaction force measurement part 543, with the target compaction force.

The target compaction force includes a lower limit FLlim and an upper limit FUlim.

The lower limit FLlim is set as the compaction force that is at least necessary for ensuring the quality of the compaction operation.

The upper limit FUlim is set as an upper limit of the compaction force at which when the compaction force is greater than the upper limit, a jack-up amount of the shovel 100 is suppressed to be equal to or less than a predetermined reference.

Note that, of the target compaction forces, the lower limit FLlim related to the quality of the compaction operation can be changed in accordance with soil. That is, when the predetermined compaction force is applied from the bucket 6 to the ground by the compaction assist control, the controller 30 may change the predetermined compaction force in accordance with soil. At this time, the controller 30 may determine the soil in accordance with a setting operation by the operator through the input device 42 (e.g., an operation to select one of a plurality of types of soil displayed on an operation screen displayed on the display device 40).

Also, the controller 30 may automatically determine the soil based on, for example, the photographed image taken by the photographing device 80. Also, in the present example, the presence or absence of an occurrence of jack-up is determined based on the compaction force, but may be determined by a given method. For example, the controller 30 may determine the presence or absence of an occurrence of jack-up based on the output of the machine body tilt sensor S4.

In this case, the controller 30 detects rising of the front of the upper swiveling body 3 from the output of the machine body tilt sensor S4, and can determine an occurrence of jack-up when the front thereof has risen to a predetermined height or a predetermined angle. Also, when the back surface of the bucket 6 brought into contact with the ground has sunk under the ground, the ground against which the bucket 6 has been pressed can be determined to be the soft ground. The controller 30 may recognize the height of the bottom surface of the crawlers as the height of the ground. Also, the controller 30 may determine the ground by the space recognition device.

The compaction force comparison part 544 also functions as a soft ground determination part. The compaction force comparison part 544 compares the compaction force Fd measured by the compaction force measurement part 543, with the lower limit FLlim and the upper limit FUlim, and determines whether the measured compaction force Fd is within a range between the lower limit FLlim and the upper limit FUlim, the range including the lower limit FLlim and the upper limit FUlim.

When the measured compaction force Fd is within the range between the lower limit FLlim and the upper limit FUlim, the range including the lower limit FLlim and the upper limit FUlim (FLlim≤Fd≤FUlim), the compaction force comparison part 544 determines that the compaction force necessary for the compaction operation is ensured and the jack-up amount can be suppressed to be equal to or less than the predetermined reference. When the measured compaction force Fd does not exceed the upper limit FUlim and the back surface of the bucket 6 has sunk under the ground (e.g., the ground surface in contact with the shovel 100), the compaction force comparison part 544 determines that the ground is the soft ground.

In this case, the ground surface in contact with the shovel 100 is set as the ground situation determination surface. Also, the ground situation determination surface may be set to be deep by a predetermined distance under the ground surface in contact with the shovel 100. By using the outputs from, for example, the position measurement device and the posture sensor, the position of the soft ground can be identified. The identified position of the soft ground is transmitted to the construction management device. Thereby, the construction management device can set the position of the soft ground in a drawing for a construction plan.

Furthermore, what is transmitted to the construction management device is not limited to the identified position of the soft ground. When the ground determination part 52 has determined that the ground of interest is not the soft ground (the ground of interest is the hard ground), the position of the ground of interest may be transmitted to the construction management device as a position at which the determination of the ground has been completed. Thereby, it is possible to prevent repeating the determination on the same region. Also, the region determined not to be the soft ground can be utilized as a traveling path for other construction machines.

Meanwhile, when the measured compaction force Fd is below the lower limit FLlim (Fd<FLlim), the compaction force comparison part 544 determines that the compaction force necessary for the compaction operation is not ensured. Then, the compaction force comparison part 544 appropriately outputs a control command to the proportional valve 31, and adjusts the movements of the attachments (the boom 4, the arm 5, and the bucket 6) so that the compaction force Fd increases. Thereby, the compaction force applied from the bucket 6 to the ground is adjusted, and the compaction force necessary for the compaction operation can be ensured.

Also, when the measured compaction force Fd exceeds the upper limit LUlim (Fd>LUlim), the compaction force comparison part 544 determines that the shovel 100 likely has a jack-up amount that is greater than the predetermined reference. Then, the compaction force comparison part 544 appropriately outputs a control command to the relief valve 33, and discharges, to the tank, the hydraulic oil of the rod-side oil chamber of the boom cylinder 7 in which an excessive pressure is occurring. Thereby, the compaction force applied from the bucket 6 to the ground is adjusted, and the jack-up amount of the shovel 100 is suppressed to be equal to or less than the predetermined reference.

During the compaction assist control, the compaction force comparison part 544 repeats the above process based on the compaction force Fd that is consecutively measured by the compaction force measurement part 543. Thereby, the compaction force applied from the bucket 6 to the ground is equal to or greater than a certain level necessary for the compaction operation, and the jack-up amount of the shovel 100 can be suppressed to be equal to or less than the predetermined reference. When the measured compaction force Fd does not exceed the upper limit FUlim and the back surface of the bucket 6 has sunk under the ground (e.g., the ground surface in contact with the shovel 100), the compaction force comparison part 544 determines that the ground is the soft ground. The controller 30 changes the traveling route in response to being determined to be the soft ground. In this case, the ground surface in contact with the shovel 100 is set as the ground situation determination surface. Also, the ground situation determination surface may be set to be deep by a predetermined distance under the ground surface in contact with the shovel 100.

For example, as illustrated in FIG. 9, in the present embodiment, the shovel 100 starts the compaction operation of compaction position PS1 in the traveling direction. The shovel 100 moves the boom 4 upward and downward, and performs the compaction operation of the compaction position PS1 with the bucket 6. Based on the compaction operation that has been performed, it is determined whether a region including the compaction position PS1 is the soft ground region.

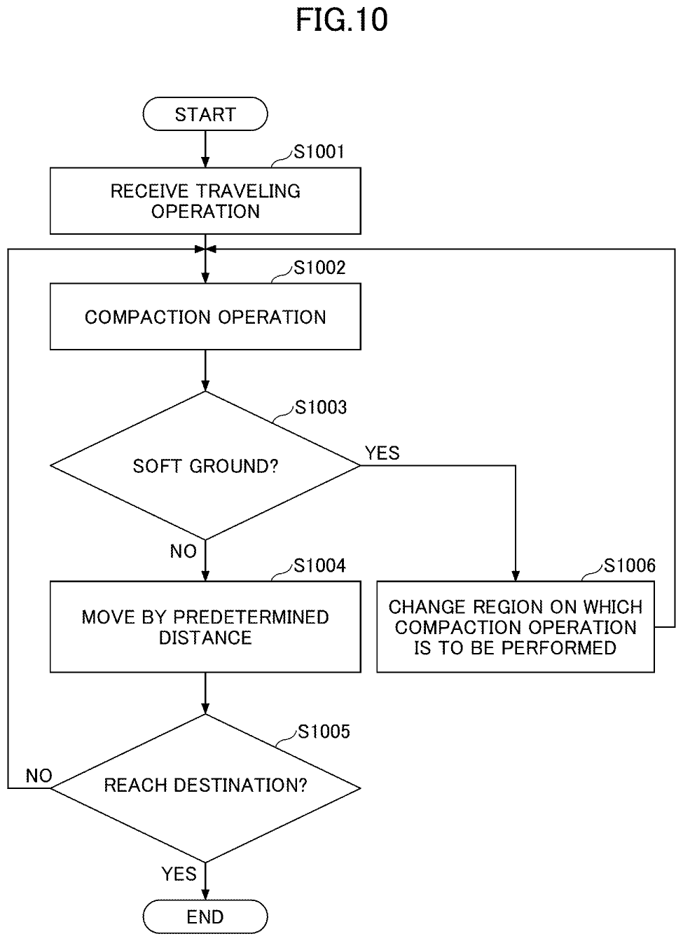

Next, referring to FIG. 10, the movement of the shovel 100 of the present embodiment will be described. FIG. 10 is an explanatory view of the movement of the shovel.

In the shovel 100 of the present embodiment, when the controller 30 is operated by the operator to instruct the shovel 100 to travel (step S1001), the controller 30 performs the compaction operation on a region in the traveling direction by the automatic control part 523 of the ground determination part 52 (step S1002). Note that, at this time, the shovel 100 may receive an input of position information indicating the position of the destination, and a direction of the current position of the shovel 100 toward the destination may be set as the traveling direction.

Here, the controller 30 does not necessarily perform the compaction operation. The controller 30 may presume the presence or absence of the soft ground by the space recognition device based on the shape of a traveling trace (shape of a track) formed by the crawlers, and determine the need to perform the compaction operation. Thereby, it is possible to determine the presence or absence of the soft ground by regarding, as a soft ground warning region, a region that is presumed as the soft ground from the depth of the traveling trace with respect to the surrounding ground. Note that, the soft ground warning region refers to a region that is likely to be the soft ground.

Also, in the present embodiment, when the ground surface in which the traveling trace has been formed reaches a predetermined depth (traveling ground determination surface) with respect to the surrounding ground, the ground on which the shovel 100 is traveling may be presumed as the soft ground warning region. The depth of the traveling trace may be detected by, for example, the output of the position measurement device V1. Also, the depth from the surrounding ground determined as the soft ground warning region (e.g., the depth from the surrounding ground to the traveling ground determination surface) is set to be shallower than the depth from the surrounding ground to the ground situation determination surface.

In this way, the controller 30 of the present embodiment can identify the position of the presumed soft ground warning region based on the output of the position measurement device V1. Also, the shovel 100 transmits, to the construction management device, the information indicating the position of the presumed soft ground warning region. Thereby, the construction management device can set the position of the soft ground warning region in a drawing for a construction plan.

Also, when the position of the soft ground warning region is set in the drawing for the construction plan, the controller 30 can determine based on the drawing for the construction plan whether the shovel 100 has entered or approached the soft ground warning region. When the shovel 100 has entered or approached the soft ground warning region, the controller 30 can determine whether the ground of the region is the soft ground by performing the compaction operation.

Also, the controller 30 may presume the presence or absence of the possibility of being the soft ground based on the past work contents in the construction site, and may determine the need to perform the compaction operation (determine the presence or absence of the possibility of being the soft ground (the soft ground warning region)). Furthermore, the controller 30 may use weather information for determining the need to perform the compaction operation. Also, a construction management device 200 may determine the need to perform the compaction operation, and transmit the determination result to the shovel 100. In this case, based on the determination result received from the construction management device 200, the controller 30 performs the compaction operation when the shovel 100 has reached the soft ground warning region.

Subsequently, the controller 30 determines whether the region on which the compaction operation has been performed is the soft ground region by the determination part 524 of the ground determination part 52 (step S1003).

In step S1003, when the region on which the compaction operation has been performed is not the soft ground region, the controller 30 permits the shovel 100 to travel by a predetermined distance (step S1004). In other words, the controller 30 moves the shovel 100 by the predetermined distance.

Subsequently, the controller 30 determines whether the shovel 100 has reached the destination (step S1005).

In step S1005, when the shovel 100 has reached the destination, the controller 30 ends the process of the ground determination part 52. Also, in step S1005, when the shovel 100 has not reached the destination, the controller 30 returns to step S1002.

In step S1003, when the region on which the compaction operation has been performed is the soft ground region, the controller 30 swivels the upper swiveling body 3 and changes the region on which the compaction operation is to be performed (step S1006), and returns to step S1002.

Note that, in the present embodiment, when all of the surrounding regions of the shovel 100 are the soft ground region, all of the surrounding regions being the soft ground region may be displayed on the display device 40, and the traveling may be stopped.

In this way, when the destination is set, the shovel 100 of the present embodiment determines the presence or absence of the soft ground region by performing the compaction operation every time the shovel 100 travels by the predetermined distance until the shovel 100 reaches the destination. When the soft ground region is present, the shovel 100 of the present embodiment can change the traveling direction, and avoid entry into the soft ground region in order to travel toward the destination.

Note that, at this time, the ground determination part 52 may obtain the position information of the region on which the compaction operation has been performed, and transmit, to the construction management device through the output part 526, information in which the determination result obtained by the determination part 524 and the position information are associated with each other.

Also, when the shovel 100 of the present embodiment has reached the destination, route information indicating a traveling route from the start point to the destination may be transmitted to the construction management device through the output part 526. In the present embodiment, in this way, by transmitting, to the construction management device, the route information indicating the traveling route that avoids traveling in the soft ground region, it is possible to share the route information with other shovels 100.

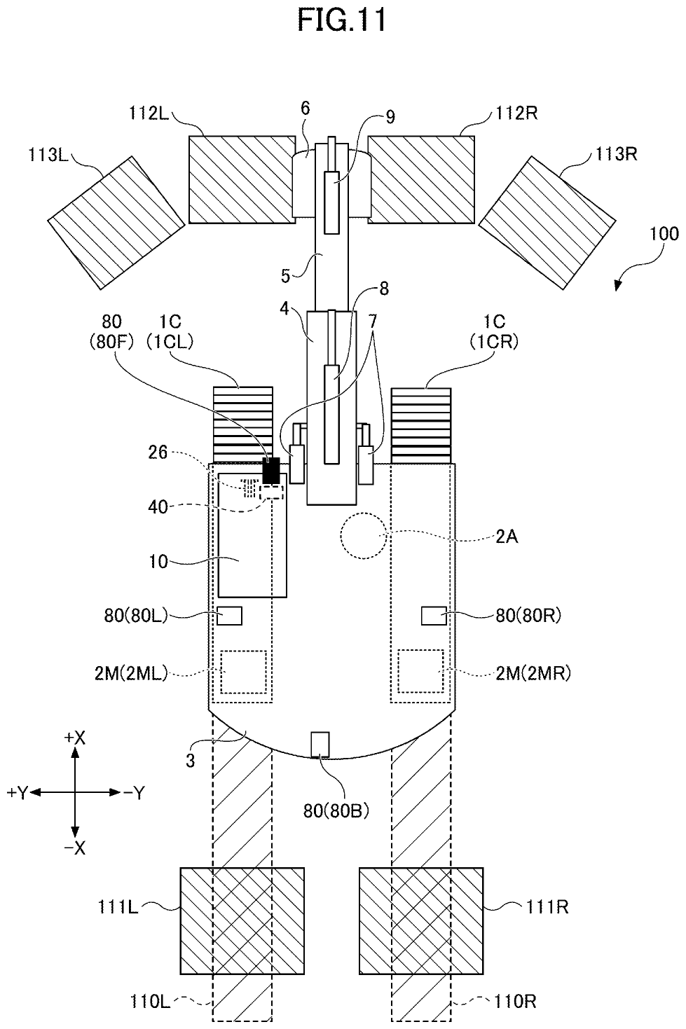

In the following, referring to FIG. 11, the effects of the present embodiment will be described. FIG. 11 is a view illustrating the effects of the present embodiment.

In FIG. 11, regions 111R and 111L indicate the regions on which the compaction operation has been performed. Also, regions 110R and 110L are the traveling traces of the shovel 100. Specifically, the region 110R is the traveling trace of a crawler 1CR, and the region 110L is the traveling trace of a crawler 1CL. In other words, the traveling trace of a crawler 1C is a track of the crawler 1C. This track is formed in the ground when the shovel 100 has traveled after the determination of the absence of the soft ground region.

At work sites, when the ground in front of the shovel 100 is softer than the regions 111R and 111L, the traveling trace becomes gradually deeper than the surrounding ground as the shovel 100 travels. When the traveling trace of the shovel 100 has reached the predetermined depth with respect to the surrounding ground (traveling ground determination surface), the ground on which the shovel 100 is traveling can be determined as the soft ground warning region. Thereby, the controller 30 determines that the shovel 100 has entered the soft ground warning region, and determines whether the region in front of the shovel 100 is the soft ground by performing the compaction operation.

In the example of FIG. 11, the shovel 100 is found to travel in the regions 111R and 111L in response to determining the absence of the soft ground region in the regions 111R and 111L as a result of the compaction operation performed on the regions 111R and 111L.

Also, in FIG. 11, the shovel 100 has moved by the predetermined distance from the point in the regions 111R and 111L on which the compaction operation was performed.

In this state, the shovel 100 performs the compaction operation on the regions 112R and 112L in the traveling direction. Note that, in the present embodiment, even if the soft ground region is absent in the regions 112R and 112L in the traveling direction, the shovel 100 may perform the compaction operation on regions other than the regions in the traveling direction. The shovel 100 may associate position information of the regions on which the compaction operation has been performed with the determination results, and store the associated information.

FIG. 11 illustrates an example in which the compaction operation is also performed on regions 113R and 113L that are the regions other than the regions 112R, 112L in the traveling direction. In the present embodiment, in this way, by performing the compaction operation on the regions other than the regions in the traveling direction and storing information indicating the determination results of the presence or absence of the soft ground region, it is possible to take advantage of this information, for example, when the shovel 100 travels toward another destination.

Also, the controller 30 may associate information indicating the determination result of the presence or absence of the soft ground region with position information and time information (e.g., date and time) and store the associated information. Also, the shovel 100 may transmit and store these items of information to and in the construction management device. The controller 30 may also associate the determination result of the presence or absence of the soft ground warning region with position information and time information (e.g., date and time) and store the associated information. Also, the shovel 100 may transmit and store these items of information to and in the construction management device.

As described above, in the present embodiment, the traveling toward the traveling direction is permitted when the soft ground region is absent by determining the presence or absence of the soft ground region in the ground in the traveling direction. Therefore, in the present embodiment, it is possible to avoid entry into the soft ground region.

By avoiding the entry into the soft ground region, for example, it is possible to avoid circumstances which would otherwise occur due to entry into the soft ground region, such as a circumstance where the traveling speed becomes lower, the time of arrival at the destination is delayed, and the work efficiency decreases. Also, in the present embodiment, by avoiding the entry into the soft ground region, for example, it is possible to avoid an issue that mud is attached to, for example, the crawlers of the shovel 100, which makes cleaning laborious.

### ANOTHER EMBODIMENT

In the following, referring to the drawings, another embodiment will be described. The other embodiment described below is different from the above-described embodiment in that the information obtained by the shovel 100 is shared in the construction management system. Therefore, in the following description of the other embodiment, the difference from the above-described embodiment will be described, and components having similar functional configurations to those in the above-described embodiment are given the symbols used for describing the above-described embodiment and description thereof will be omitted.

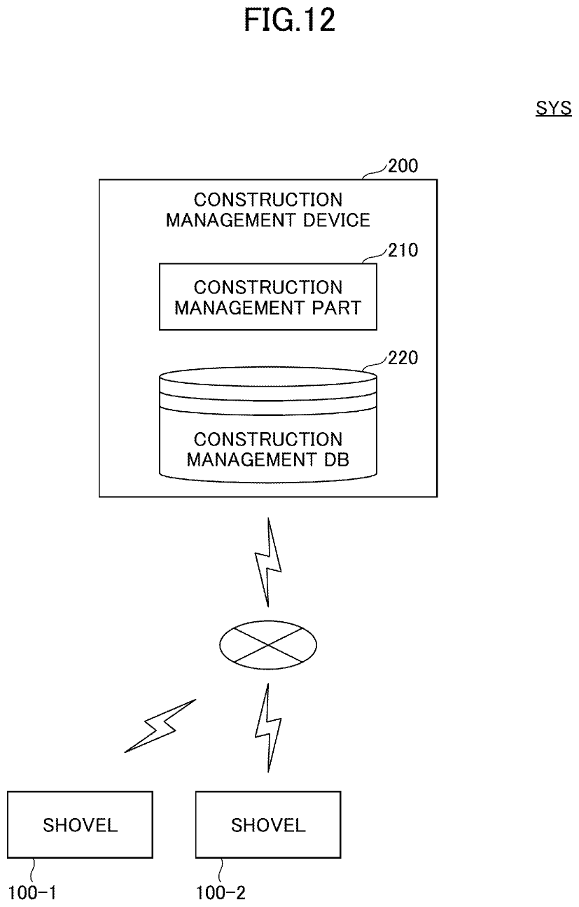

FIG. 12 is a view illustrating one example of the system configuration of the construction management system. A construction management system SYS includes a construction management device 200, a shovel 100-1, and a shovel 100-2, and the construction management device 200 and the shovels 100-1 and 100-2 communicate with each other via, for example, a network. Note that, in the example of FIG. 12, although the number of the shovels 100 included in the construction management system SYS is two, the number of the shovels 100 included in the construction management system SYS may be a given number.

In the present embodiment, for example, the shovels 100-1 and 100-2 work in a single construction site. Each of the shovels 100-1 and 100-2 has a similar configuration to that of the shovel 100 in the above-described embodiment.

Also, in the present embodiment, when the shovels 100-1 and 100-2 travel toward the same destination in the construction site, one of the shovels 100 obtains route information indicating a traveling route to the destination from the construction management device 200, and the other shovel 100 follows a track of the one shovel 100. In the following description, the shovels 100-1 and 100-2 are referred to as the shovel 100 if they are not distinguished from each other.

The construction management device 200 is a computer having the function of managing the construction site in which the shovels 100-1 and 100-2 work.

The construction management device 200 of the present embodiment includes a construction management part 210 and a construction management database 220.

The construction management part 210 performs, for example, control of the movement of the shovel 100 and obtainment of information indicating the state of the construction site. Specifically, the construction management part 210 stores various information collected from the shovel 100 in the construction management database 220. Also, the construction management part 210 refers to the information stored in the construction management database 220, and provides the shovel 100 with route information indicating a traveling route to the destination.

The construction management database 220 stores the information collected from the shovel 100.

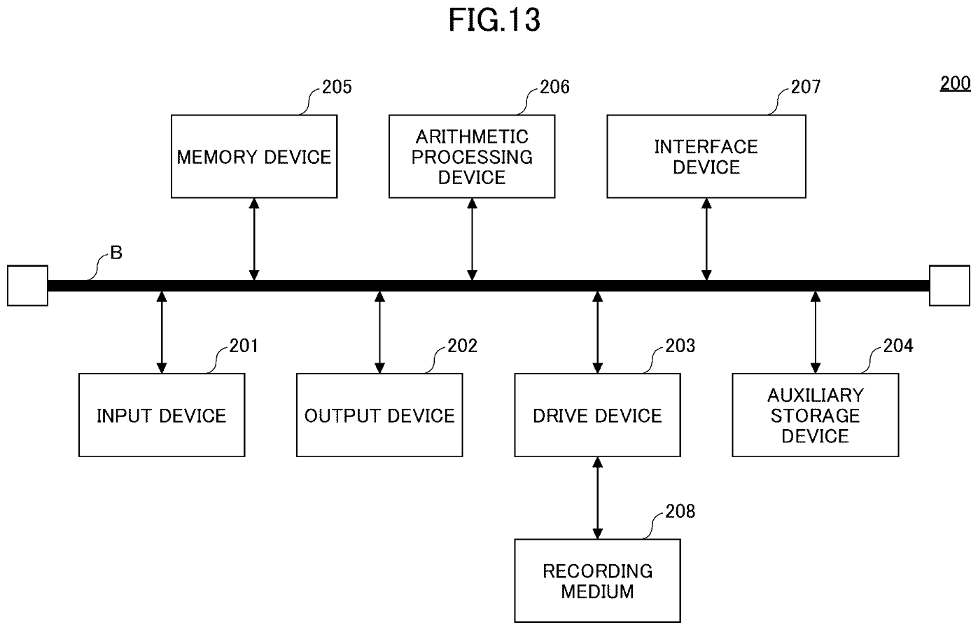

In the following, the construction management device 200 of the present embodiment will be further described. FIG. 13 is a view illustrating one example of the hardware configuration of the construction management device.

The construction management device 200 of the present embodiment is a computer including an input device 201, an output device 202, a drive device 203, an auxiliary storage device 204, a memory device 205, an arithmetic processing device 206, and an interface device 207, which are connected to each other via a bus B.

The input device 201 is a device for inputting various information and may be realized by, for example, a keyboard or a pointing device. The output device 202 is for outputting various information and is realized by, for example, a display. The interface device 207 includes a LAN card or the like and is used for connecting to a network.

A construction management program that realizes the construction management part 210 is at least a part of various programs that control the construction management device 200. The construction management program is provided by, for example, a recording medium 208 distributed or downloading from a network. The recording medium 208 storing the construction management program can be various types of recording media, for example, recording media that optically, electrically, or magnetically record information, such as CD-ROMs, flexible discs, magneto-optical discs, and the like, and semiconductor memories that electrically record information, such as ROMs, flash memories, and the like.

Also, when the recording medium 208 storing the construction management program is set in the drive device 203, the construction management program is installed in the auxiliary storage device 204 from the recording medium 208 via the drive device 203. The construction management program downloaded from the network is installed in the auxiliary storage device 204 via the interface device 207.

The auxiliary storage device 204 realizes the construction management database 220 and the like included in the construction management device 200, and stores the construction management program installed in the construction management device 200 and stores, for example, various necessary files and data for the construction management device 200. The memory device 205 reads out the construction management program from the auxiliary storage device 204 upon starting up the construction management device 200, and stores the construction management program. The arithmetic processing device 206 realizes various processes as described below in accordance with the construction management program stored in the memory device 205.

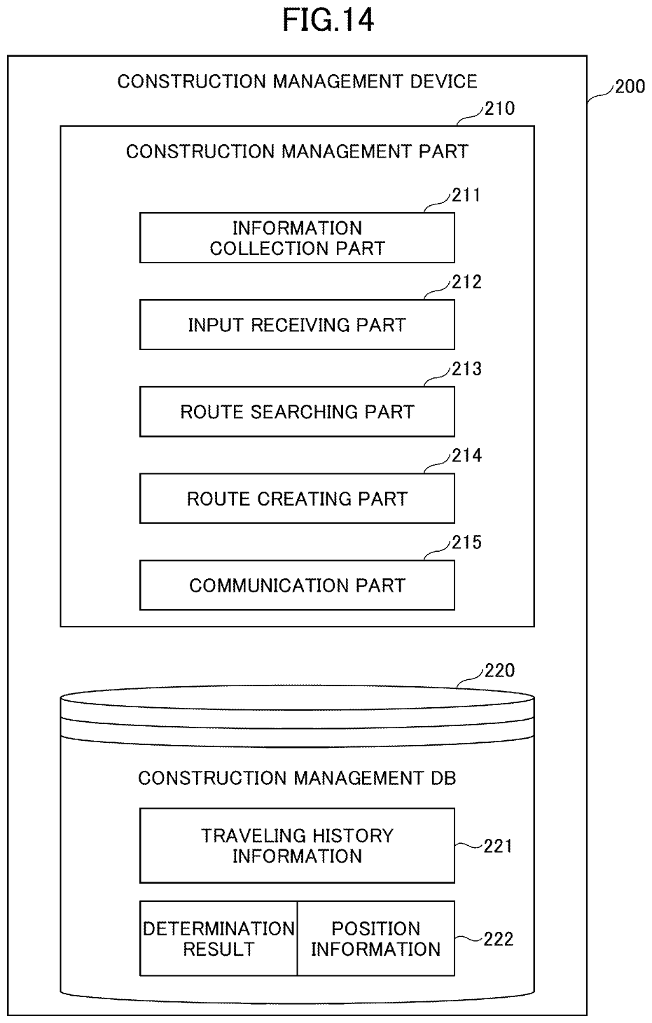

Next, referring to FIG. 14, the functions of the construction management device 200 of the present embodiment will be described. FIG. 14 is an explanatory view illustrating the functions of the construction management device.

The construction management part 210 of the construction management device 200 of the present embodiment includes an information collection part 211, an input receiving part 212, a route searching part 213, a route creating part 214, and a communication part 215.

The information collection part 211 of the present embodiment collects various information from the shovel 100 included in the construction management system SYS, and stores the information in the construction management database 220. The information collected from the shovel 100 is, for example, traveling history information 221 indicating a travel history of the shovel 100, and determination result information 222 in which position information of the regions on which the compaction operation has been performed and the determination results are associated with each other.

The input receiving part 212 of the present embodiment receives various inputs from the shovel 100. Specifically, the input receiving part 212 receives inputs such as a demand-to-obtain from the shovel 100 to obtain a traveling route. Note that, the demand-to-obtain to obtain the traveling route includes position information indicating the current position of the shovel 100, and information indicating the destination.

In accordance with the demand-to-obtain for the traveling route received by the input receiving part 212, the route searching part 213 searches the construction management database 220 and identifies the applicable traveling history information.

When the applicable traveling history information is absent in the construction management database 220 as a result of the search by the route searching part 213, the route creating part 214 creates a traveling route to the destination. At this time, the route creating part 214 creates a traveling route that avoids the soft ground region.

The communication part 215 transmits the traveling history information, which has been obtained by the route searching part 213 as the search result, to the shovel 100 as the route information indicating the traveling route. Also, the communication part 215 transmits, to the shovel 100, the route information indicating the traveling route created by the route creating part 214.

The construction management database 220 of the present embodiment stores the traveling history information 221 indicating the travel history of the shovel 100, and the determination result information 222 in which the position information of the regions on which the compaction operation has been performed is associated with the determination results.

The traveling history information 221 is information indicating a traveling route through which the shovel 100 traveled in the past. The traveling history information 221 of the present embodiment may include information indicating the date and time when the shovel 100 traveled through the traveling route, the weather information when the shovel 100 traveled, and the like.

The traveling history information 221 of the present embodiment is information indicating the traveling route through which the shovel 100 working in the construction site traveled while confirming the presence or absence of the soft ground region by the ground determination part 52. In other words, the traveling route indicated by the traveling history information is a route where the soft ground region was absent over the course of travel. The traveling history information 221 of the present embodiment is extracted as the search result by the route searching part 213, and provided to the shovel 100 as the route information.

The determination result information 222 includes position information of the regions on which the compaction operation has been performed, and information indicating the determination results of the presence or absence of the soft ground region. Also, the determination result information 222 may include identification information for identifying the shovel 100 that performed the compaction operation, information indicating the date and time when the shovel 100 performed the compaction operation, the weather information when the compaction operation was performed, and the like.

Note that, the construction management database 220 may include information other than the traveling history information 221 and the determination result information 222. Specifically, the construction management database 220 may store information indicating the address of the construction site, a construction period, weather information in the construction site during the construction period, information in relation to the shovel 100 working in the construction site, and the like. The information in relation to the shovel 100 includes the number of the shovels 100 working in the construction site, image data (video data) taken by the respective shovels 100, and the like.

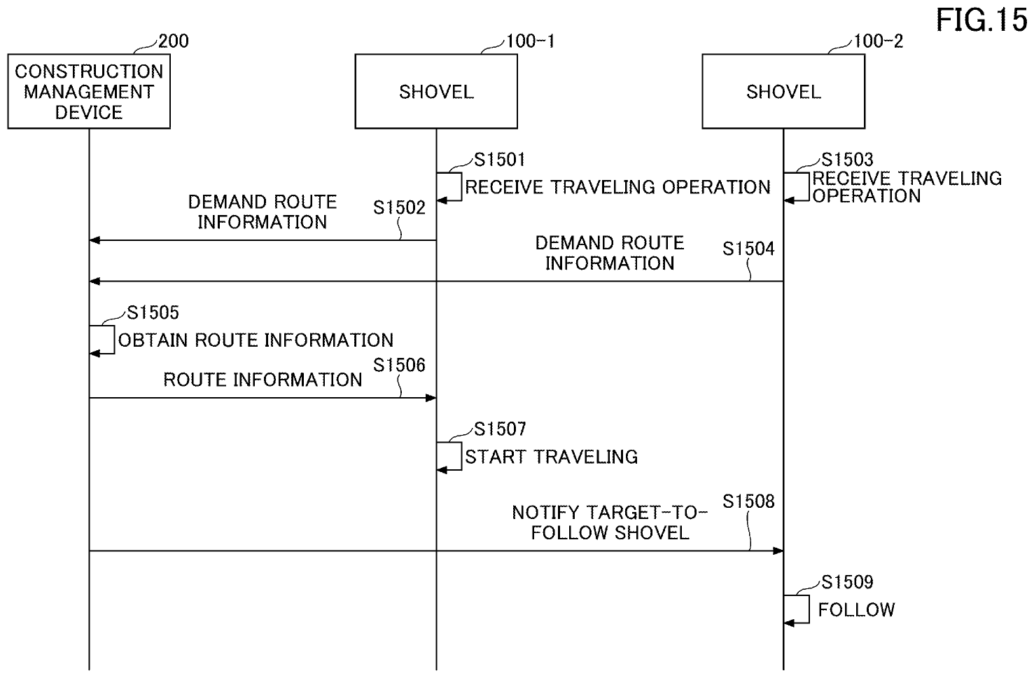

Next, referring to FIG. 15, the operation of the construction management system SYS of the present embodiment will be described. FIG. 15 is a sequence diagram illustrating the operation of the construction management system. FIG. 15 illustrates, for example, an operation when the shovels 100-1 and 100-2 travel toward the same destination in the construction site.

In the construction management system SYS, when the shovel 100-1 has received an input of the destination and an operation to instruct the start of traveling (step S1501), the shovel 100-1 transmits, to the construction management device 200, a demand-to-obtain for route information indicating a traveling route to the destination (step S1502).

Note that, information indicating the current position of the shovel 100-1 obtained by the information obtainment part 521 of the shovel 100-1, and information indicating the position of the destination are included in this demand-to-obtain. The information indicating the position of the destination may be obtained by the information obtainment part 521.

Also, this demand-to-obtain may include identification information for identifying the shovel 100 that has transmitted the demand-to-obtain.

Also, when the shovel 100-2 has received an input of the destination and an operation to instruct the start of traveling (step S1503), the shovel 100-2 transmits, to the construction management device 200, a demand-to-obtain for route information indicating a traveling route to the destination (step S1504). This demand-to-obtain includes information indicating the current position of the shovel 100-2, and information indicating the position of the destination.

The construction management device 200 receives the demand-to-obtain for the route information from the shovels 100-1 and 100-2 through the input receiving part 212, and obtains route information indicating a traveling route to the destination through the route searching part 213 or the route creating part 214 (step S1505).

The route information obtained here is route information that has been confirmed about the absence of the soft ground region over the course of travel. Details of the process of step S1505 will be described below.

Subsequently, the construction management device 200 transmits the obtained route information to the shovel 100-1 through the communication part 215 (step S1506). When the shovel 100-1 has received the route information, the shovel 100-1 starts to travel based on the route information through the automatic control part 523 (step S1507).

Subsequently, the construction management device 200 transmits, to the shovel 100-2 through the communication part 215, information indicating that the shovel 100-1 is the shovel 100 that is a target-to-follow (step S1508). This information may include identification information for identifying the shovel 100-1, and position information indicating the current position of the shovel 100-1.

When the shovel 100-2 has received this notification, the shovel 100-2 travels by following the track formed in the ground by the traveling of the shovel 100-1 (step S1509). Details of the process of step S1509 will be described below.

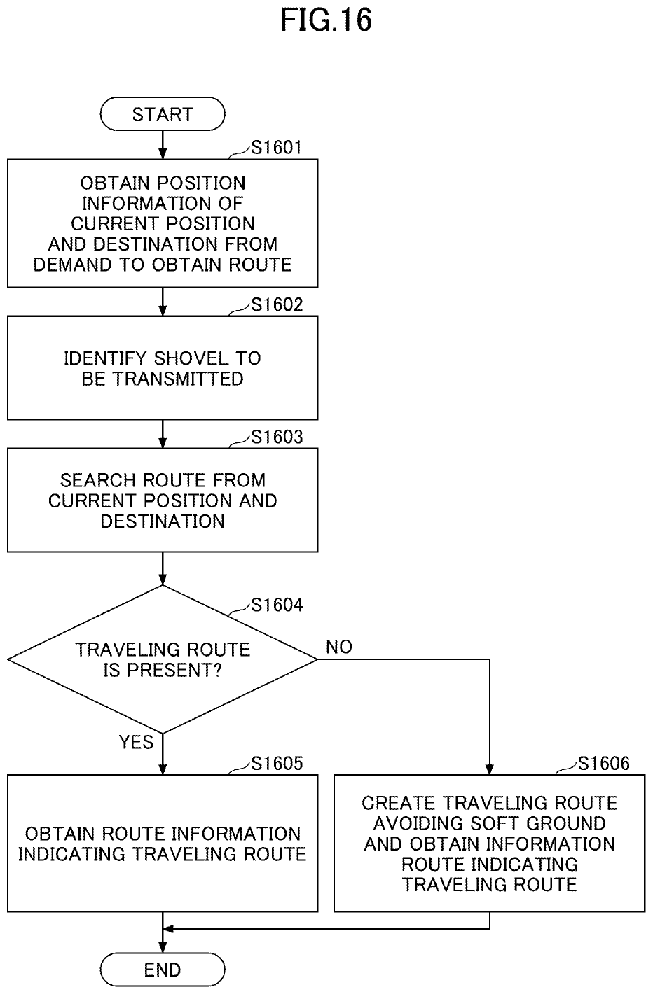

Next, referring to FIG. 16, the process of the construction management device 200 of the present embodiment will be described. FIG. 16 is a flowchart illustrating the process of the construction management device. FIG. 16 illustrates details of the process of step S1505 in FIG. 15.

The construction management device 200 of the present embodiment obtains, in response to a demand-to-obtain for route information of the shovel 100, position information indicating the current position of the shovel 100 and position information indicating the destination included in this demand-to-obtain through the route searching part 213 of the construction management part 210 (step S1601).

Subsequently, the route searching part 213 identifies the shovel 100 that has transmitted the route information and the shovel 100 that is to follow the shovel 100 that has transmitted the route information, based on the position information of the current position of the shovel 100 and the position information indicating the destination (step S1602).

In other words, the route searching part 213 identifies, of the shovel 100-1 and the shovel 100-2, the shovel 100 to be followed by the other shovel 100 and the shovel 100 to follow the track of the other shovel 100. In the following description, the shovel 100 to be followed by the other shovel 100 may be referred to as a target-to-follow shovel 100.

Specifically, for example, the route searching part 213 may set, as the target-to-follow shovel 100, the shovel 100 whose current position is closer to the destination. Also, the route searching part 213 may set, as the target-to-follow, the shovel 100 whose current position is farther from the destination.

In the present embodiment, the target-to-follow shovel 100 is previously set, and the route searching part 213 may identify the target-to-follow shovel 100 based on the identification information of the shovel 100 included in the demand-to-obtain for the route information.

Subsequently, the route searching part 213 searches the construction management database 220 (step S1603). At this time, the route searching part 213 searches a traveling route to the destination with the starting point being set as the current position of the target-to-follow shovel 100.

Subsequently, the route searching part 213 determines whether an applicable traveling route is present (step S1604). In step S1604, when an applicable traveling route is present, the route searching part 213 extracts and obtains, as the route information, the traveling history information indicating the applicable traveling route (step S1605). Then, the process proceeds to step S1505 in FIG. 15.

In step S1604, when the applicable traveling route is absent, the route creating part 214 of the construction management part 210 refers to the determination result information 222, and creates a traveling route through the regions in which the soft ground region is determined as being absent and obtains route information indicating the traveling route (step S1606). Then, the process proceeds to step S1505 in FIG. 15.

Specifically, the route creating part 214 may refer to the determination result information 222 and extract a region of a predetermined scope around the center that is the position information associated with the determination result of being “not the soft ground region” (position information indicating the position on which the compaction operation has been performed), and connect the extracted region to the destination, thereby creating the traveling route.

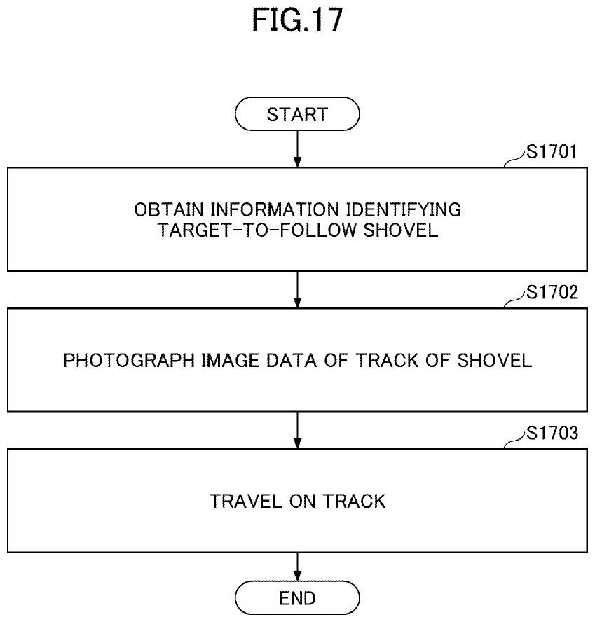

Next, referring to FIG. 17, the movement of the shovel 100-2 following the track formed after the traveling of the target-to-follow shovel 100-1 will be described.

FIG. 17 is a flowchart illustrating the movement of the shovel that follows the track. The shovel 100-2 of the present embodiment obtains, from the construction management device 200, information indicating identification information for the target-to-follow shovel 100-1 (step S1701).

Subsequently, the shovel 100-2 uses the photographing device 80 to photograph an image of the track of the target-to-follow shovel 100-1 (step S1702).

Specifically, the shovel 100-2 may photograph the image of the track of the shovel 100-1 with any one of the camera 80F, the camera 80B, the camera 80L, and the camera 80R included in the photographing device 80.

Subsequently, the shovel 100-2 starts to travel on the track of the shovel 100-1 (step S1703). Note that, in this case, the shovel 100-2 may detect the image of the track through image analysis on the image photographed by the photographing device 80.

As described above, according to the present embodiment, in a case where, for example, a plurality of shovels 100 work in the same construction site, it is possible to share information such as the presence or absence of the soft ground region in the construction site, and the position of the soft ground region. Therefore, in the present embodiment, not all of the shovels 100 need to perform an operation to confirm the presence or absence of the soft ground region in the traveling direction, and this makes it possible to efficiently progress the intended work.

Note that, in the present embodiment, when the plurality of shovels 100 are present in the construction site, the shovel 100 to be the target-to-follow is identified, the route information indicating the traveling route that avoids the soft ground region is transmitted to the identified shovel 100 only, and the other shovel 100 follows the track of this shovel 100. However, this is by no means a limitation.

The construction management device 200 may transmit, to each of the plurality of shovels 100, the route information indicating the traveling route that avoids the soft ground region. In this case, all of the shovels 100 can independently travel based on the route information. Therefore, this is useful, for example, when the image of the track cannot be detected due to poor visibility or the like.

Also, in the present embodiment, when the shovel 100-2 cannot detect the image of the track of the target-to-follow shovel 100-1 after obtaining the information identifying the shovel 100-1, the shovel 100-2 may perform the demand-to-obtain again for the route information on the construction management device 200.

When the construction management device 200 has received again the demand-to-obtain for the route information after notifying the shovel 100-2 of the information identifying the target-to-follow shovel 100-1, the construction management device 200 may obtain the route information indicating the traveling route from the current position of the shovel 100-2 to the destination, and transmit the obtained route information to the shovel 100-2.

At this time, when the current position of the shovel 100-2 is within the region including the current position of the shovel 100-1, the construction management device 200 may transmit, to the shovel 100-2, similar route information to the route information transmitted to the shovel 100-1.

Also, in the present embodiment, the plurality of shovels 100 in the construction site share the information via the construction management device 200. However, this is by no means a limitation.

For example, the shovel 100-1 may transmit, to the shovel 100-2, the determination result information 222 obtained by the process of the ground determination part 52. The shovel 100-2 receives this determination result information 222, and may determine the traveling route based on this determination result information 222.

Also, the shovel 100-1 may transmit, to the shovel 100-2, information indicating that the shovel 100-1 is the target-to-follow.

Also, when the shovel 100-1 has received an operation to instruct traveling in, for example, step S1001 in FIG. 10, the shovel 100-1 may transmit, to the shovel 100-2, information indicating that the shovel 100-1 is the target-to-follow. In this case, the shovel 100-1 travels while performing the compaction operation to avoid the soft ground region. The shovel 100-2 may travel so as to follow the track formed in the ground by the traveling of the shovel 100-1.

Also, when the shovel 100-1 has reached the destination while avoiding the soft ground region by the process of FIG. 10, the shovel 100-1 may transmit, to the construction management device 200, a notification indicating that the shovel 100-1 has reached the destination, together with the traveling history information 221 and the determination result information 222.

The construction management device 200 receives this notification and may transmit, to the shovel 100-2, information indicating that the shovel 100-1 is the target-to-follow. Also, the construction management device 200 receives this notification and may transmit, to the shovel 100-2, the traveling history information 221 as the route information.

Also, the construction management system SYS of the present embodiment may include an assist device that assists the operator of the shovel 100 in the construction site. The assist device may be a tablet-type terminal device, a smartphone, or the like. The shovel 100 transmits the determination result information 222 to the assist device, and the assist device may display the determination result information 222.

Note that, the construction management device 200 of the present embodiment may delete the traveling history information 221 and the determination result information 222 that, for example, passed a certain period of time from being stored in the construction management database 220.

Also, the construction management device 200 of the present embodiment may delete the traveling history information 221 and the determination result information 222 that, for example, were stored in the construction management database 220 based on the weather information. Specifically, for example, when it rained at a predetermined level or higher in the construction site, the information stored in the construction management database 220 may be deleted.

In this way, by updating the construction management database 220, it is possible to refer to the information indicating the current status of the construction site, and obtain the route information that avoids the soft ground region.

Although the preferable embodiments of the present disclosure have been described in detail, the present disclosure is not limited to the above-described embodiments, and various alterations and substitutions can be added to the above-described embodiments without departing from the scope of the present disclosure.

What is claimed is:

1. A shovel, comprising:
a determination part that presses a working portion of an end attachment against a ground, and determines presence or absence of a soft ground region in the ground; and
a control part that permits the shovel to travel by a predetermined distance in response to the determination part determining the absence of the soft ground region.

2. The shovel according to claim 1, wherein the predetermined distance is a distance from a current position of the shovel to a region against which the working portion is pressed.

3. The shovel according to claim 1, further comprising:
a storage part that stores determination result information in which a determination result obtained by the determination part is associated with position information indicating a position of a region against which the working portion is pressed.

4. The shovel according to claim 3, wherein the shovel obtains route information indicating a traveling route of the shovel traveling from a current position of the shovel to a destination based on the determination result obtained by the determination part, and stores the route information in the storage part.

5. The shovel according to claim 4, wherein the shovel obtains the route information obtained by another shovel, and travels based on the route information.

6. The shovel according to claim 1, further comprising:
a photographing device that photographs an image including an image of a track formed in the ground by another shovel traveling in response to determining the absence of the soft ground region,
wherein the shovel travels through the image of the track.

7. The shovel according to claim 1, wherein the determination part determines that a ground region in contact with the working portion is the soft ground region in a case where the working portion sinks relative to a ground surface in contact with crawlers by a predetermined distance or greater upon pressing the working portion against the ground at a predetermined pressing force.

8. The shovel according to claim 1, wherein the determination part determines that a ground region in contact with the working portion is the soft ground region in a case where the working portion is pressed against the ground and the working portion reaches a ground situation determination surface, the ground situation determination surface being a position under a ground surface in contact with crawlers by a predetermined distance.

9. A construction management system that manages a plurality of shovels,
at least one of the plurality of shovels comprising
a determination part that presses a working portion of an end attachment against a ground, and determines presence or absence of a soft ground region in the ground,
a control part that permits the at least one shovel to travel by a predetermined distance in response to the determination part determining the absence of the soft ground region, and
an output part that outputs route information indicating a traveling route through which the at least one shovel travels from a current position of the shovel to a destination based on a determination result of the determination part, and
the construction management system comprising
a communication part that transmits the route information, which is output from the at least one shovel, to another shovel of the plurality of shovels.

10. The construction management system according to claim 9, further comprising:
an information collection part that collects, from the at least one shovel, determination result information in which the determination result obtained by the determination part is associated with position information indicating a position of a region against which the working portion is pressed, and stores the determination result information in a construction management storage part, and
a route creating part that refers to the determination result information and creates a traveling route that avoids the soft ground region,
wherein the communication part transmits the traveling route, which is created by the route creating part, to the another shovel.

11. The shovel according to claim 4, further comprising:
a communication part that
transmits information indicating the current position and information indicating the destination to a construction management device including a construction management storage part storing the determination result information and the traveling route, and
receives the route information indicating the traveling route from the current position to the destination, from the construction management device.

12. The shovel according to claim 11, further comprising:
an automatic control part that starts traveling based on the route information received by the communication part.

13. The shovel according to claim 1, wherein the soft ground region is a region in which a ground surface sinks relative to a ground surface in contact with crawlers by a predetermined distance or greater upon being pressed by the working portion at a predetermined pressing force.

14. The shovel according to claim 1, wherein the control part
performs determination by the determination part in response to an operation to instruct traveling, and
moves the shovel by the predetermined distance in response to the traveling by the predetermined distance being permitted based on a determination result, or
rotates an upper swiveling body and changes a region against which the working portion is to be pressed in response to the traveling by the predetermined distance being not permitted based on a determination result.

15. The shovel according to claim 14, wherein in a case where all surrounding regions of the shovel are the soft ground region, the control part allows a display device to display that all the surrounding regions of the shovel are the soft ground region and stops the traveling.
